(19) United States
(12) Patent Application Publication
(10) Pub. No.: US 2026/0365582 A1
(43) Pub. Date: Nov. 19, 2026

(54) FLUORIDE-BASED NANO-COMPOSITES AND A METHOD OF PRODUCING THEREOF

(71) Applicant: Venkata S Reddy Channu, Ann Arbor, MI (US)

(72) Inventor: Venkata S Reddy Channu, Ann Arbor, MI (US)

(21) Appl. No.: 19/385,613

(22) Filed: Nov. 11, 2025

Related U.S. Application Data
(60) Provisional application No. 63/805,203, filed on May 13, 2025.

(51) Int. Cl. C04B 35/553; C01F 5/28; C01F 11/22; C04B 35/645

(52) U.S. Cl. CPC C04B 35/553; C01F 5/28; C01F 11/22; C04B 35/6455; C01P 2002/72; C01P 2002/85; C01P 2002/88; C01P 2004/03; C04B 2235/445; C04B 2235/9653

(57) ABSTRACT

A fluoride-based nanocomposite comprising magnesium fluoride (MgF₂) and calcium fluoride (CaF₂) is disclosed. The nanocomposite is a stable two-phase system below approximately 984 °C and exhibits infrared transmittance greater than 90% in the 3-9 μm wavelength range. The MgF₂ phase is uniformly dispersed within a CaF₂ matrix, providing grain boundary pinning that refines microstructure and enhances mechanical durability. The material is fabricated by precipitation, hydrothermal, wet-chemical, solid-state, or combustion synthesis, followed by spark plasma sintering (SPS), hot pressing (HP), cold isostatic pressing (CIP), or hot isostatic pressing (HIP) to achieve >99% relative density. The resulting ceramic disks demonstrate high optical clarity, low emissivity, and excellent thermal stability. Also disclosed are methods for producing such nanocomposites and their use in infrared windows, domes, laser transmission optics, and optical sensors requiring transparency and mechanical strength under harsh operational conditions.

### CROSS REFERENCE TO RELATED APPLICATIONS

This application claims priority from a U.S. Provisional Patent Appl. No. 63/805,203, filed on May 13, 2025, which is incorporated herein by reference in its entirety.

### FIELD OF INVENTION

The present invention relates generally to fluoride-based nanocomposite materials and infrared-transparent ceramics derived therefrom. More particularly, the invention is directed to magnesium fluoride-calcium fluoride (MgF₂-CaF₂) nanocomposites and infrared-transparent ceramics exhibiting enhanced optical transmission, mechanical strength, and thermal stability. The invention further pertains to methods of synthesizing and densifying such nanocomposites through multi-step fabrication processes, including spark plasma sintering, hot pressing, and hot isostatic pressing. The resulting materials are suitable for use in infrared windows, domes, laser optics, and sensor systems operating under harsh or high-temperature environments.

### BACKGROUND

Transparent ceramics are widely utilized in applications such as lasers, infrared (IR) windows, scintillators, and photoluminescent materials. Among these, infrared-transparent ceramics—including sapphire (Al₂O₃), spinel (MgAl₂O₄), yttrium oxide (Y₂O₃, yttria), and magnesium fluoride (MgF₂)—have attracted significant attention for infrared window and dome applications due to their optical performance in the mid-infrared (mid-IR) region. Sapphire (Al₂O₃) is recognized as a strong candidate material owing to its superior strength compared to other mid-wave dome materials at room temperature; however, its mechanical strength degrades markedly above approximately 600 °C. Alternative materials such as Y₂O₃ and MgF₂ offer improved optical transmittance but exhibit lower mechanical durability under elevated temperatures or harsh environments.

To obtain infrared materials with both enhanced optical and mechanical properties, one effective approach is to reduce the grain size of the ceramic microstructure. According to the Hall-Petch relationship, finer grains can yield higher strength and hardness. A well-established means of achieving grain refinement is the dispersion of second-phase particles, which impede grain-boundary migration and suppress grain growth during densification.

For instance, magnesium oxide (MgO) is often introduced as a second phase within yttrium oxide (Y₂O₃) to form a nanocomposite, since both are high-performance infrared ceramics possessing low emissivity and long-wavelength cutoffs. Although a mismatch in refractive indices between Y₂O₃ and MgO can cause scattering losses at the interfaces and reduce transmittance, such losses can be minimized if the composite grain size is maintained at approximately one-fifteenth of the incident light wavelength.

Various fabrication techniques—including hot pressing (HP), spark plasma sintering (SPS), and microwave combustion—have been employed to produce Y₂O₃-MgO nanocomposite ceramics with grain sizes of about 100-200 nm and transmittance near 80% across the 3-7 μm wavelength range. Similarly, Gd₂O₃-MgO nanocomposites fabricated at around 1350 °C have demonstrated transmittance levels of 80-85% in the 3-6 μm range.

Despite these advances, most high-transmission nanocomposite ceramics reported to date are oxide-based systems, which continue to exhibit limitations such as insufficient infrared transmission beyond the mid-IR range, reduced thermal shock resistance, and degradation under extreme operating conditions. Accordingly, there remains a need in the art for improved infrared-transparent ceramic materials that combine superior optical transmittance, mechanical strength, and thermal stability, particularly for demanding infrared window and dome applications.

### SUMMARY OF THE INVENTION

The following presents a simplified summary of one or more embodiments of the present invention in order to provide a basic understanding of such embodiments. This summary is not intended to be an extensive overview of all contemplated embodiments and is not meant to identify key or critical elements of all embodiments or to delineate the scope of any or all embodiments. Its sole purpose is to present certain concepts of one or more embodiments in a simplified form as a prelude to the more detailed description that follows.

The principal object of the present invention is to provide fluoride-based nanocomposites and all-metal fluoride infrared transparent ceramics.

Another object of the present invention is to provide fluoride-based nanocomposite ceramics exhibiting excellent optical properties.

A further object of the present invention is to provide fluoride-based nanocomposite ceramics with long wavelength cutoff and low emissivity.

In one aspect, the present invention provides fluoride-based nanocomposites and methods of preparing the same. The invention further provides ceramics derived from the fluoride-based nanocomposites that exhibit excellent optical properties.

In one embodiment, the invention discloses a two-phase mixture of calcium fluoride (CaF₂) and magnesium fluoride (MgF₂) that is stable at temperatures below approximately 984 °C. Neither magnesium fluoride nor calcium fluoride demonstrates significant absorption in the 3-5 μm wavelength range, making them suitable candidates for infrared transparent ceramics.

In another embodiment, MgF₂-CaF₂ nanocomposite ceramic powders are synthesized using co-precipitation, solid-state reaction, or combustion methods. The nanocomposite powders may be consolidated by hot-pressing (HP) or spark plasma sintering (SPS) to fabricate fully dense nanocomposite ceramics.

In one aspect, disclosed is a fluoride-based nanocomposite comprising a first phase of calcium fluoride (CaF₂) and a second phase of magnesium fluoride (MgF₂) uniformly dispersed within the calcium fluoride matrix. The nanocomposite is stable at temperatures below approximately 984 °C, has a relative density of at least 99%, and exhibits optical transmittance greater than 90% in the 3-9 μm infrared wavelength range. An average grain size of the CaF₂ first phase is between 2 μm and 50 μm, and an average grain size of the MgF₂ second phase is between 200 nm and 2 μm. The MgF₂ second phase acts as a grain boundary pinning agent, suppressing grain growth of CaF₂ and enhancing mechanical strength. The refractive index difference between CaF₂ first phase and the MgF₂ second phase is less than 0.05, thereby reducing scattering losses. The nanocomposite exhibits long-wavelength cutoff beyond 8 μm and emissivity less than 0.3.

In one aspect, disclosed is a method of producing a fluoride-based nanocomposite, comprising the steps of synthesizing calcium fluoride (CaF₂) and magnesium fluoride (MgF₂) nanopowders via one or more methods selected from precipitation, hydrothermal synthesis, wet-chemical synthesis, combustion synthesis, or solid-state reaction; mixing the nanopowders to form a precursor having a predetermined CaF₂-to-MgF₂ ratio; drying and milling the precursor to achieve a particle size between 50 nm and 1000 nm; and densifying the precursor using one or more techniques selected from spark plasma sintering (SPS), hot pressing (HP), cold isostatic pressing (CIP), or hot isostatic pressing (HIP). The densification is conducted under controlled atmosphere conditions to achieve relative density greater than 99% and infrared transmittance exceeding 90% in the 3-9 μm range. MgF₂ is incorporated as a second-phase particle to inhibit grain growth in CaF₂ through grain boundary pinning or Zener drag mechanisms. Boron nitride (BN) coatings may be applied to the sintering dies and graphite tooling to improve surface finish and facilitate demolding. The densification may be performed at 600-1100 °C for 0.5-4 hours under vacuum or inert gas atmosphere. The sintered ceramic can be polished to optical quality, producing disks with transmission greater than 90% at 3-9 μm wavelengths.

In one aspect, disclosed are infrared-transparent components, such as infrared windows, domes, laser transmission optics, optical sensors, and missile guidance systems. The infrared-transparent components are made from fluoride-based nanocomposites, the fluoride-based nanocomposites comprising a first phase of calcium fluoride (CaF₂); and a second phase of magnesium fluoride (MgF₂) uniformly dispersed within the calcium fluoride matrix. The nanocomposite is stable at temperatures below approximately 984 °C, has a relative density of at least 99%, and exhibits optical transmittance greater than 90% in the 3-9 μm infrared wavelength range. The infrared-transparent component can operate in a harsh thermal or mechanical environment exceeding 600 °C, maintaining structural integrity and optical performance. The infrared window exhibits low emissivity (<0.3) and high resistance to thermal shock. The infrared-transparent component shows broadband transmittance of at least 85% across 3-12 μm and a fracture strength greater than 150 MPa.

In one aspect, the MgF₂-CaF₂ nanocomposites show exceptional thermodynamic stability below approximately 984 °C, which distinguishes it from other systems that phase-separate or react at elevated temperatures. Moreover, the infrared transmittance of >90% in the 3-9 μm range make the nanocomposites useful in number of advanced applications. Also, the low refractive index mismatch between MgF₂ and CaF₂ minimizes scattering losses and enables high optical clarity. The nanocomposites feature controlled grain sizes, for example: MgF₂ phase≈200-300 nm embedded in a CaF₂ matrix with grain sizes≈2-50 μm. The disclosed ceramics shows improved mechanical strength, hardness, and thermal stability compared with monolithic CaF₂ or MgF₂ ceramics.

In certain aspects, the disclosed method allows producing fully dense ceramics composed of phase-pure MgF₂ and CaF₂ in purity greater than 99% as verified by XRD.

Include the nanostructured morphology as a distinctive attribute (particle sizes 50-1000 nm prior to sintering). The method includes controlled pH in a range of 8-11, specific heating profiles (e.g., 2 °C/min to 500-700 °C), and ball milling for agglomerate reduction. Also, controlled atmosphere, such as vacuum or inert gas during densification, are used to prevent oxidation or hydrolysis.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 illustrates XRD patterns of CaF₂ nanostructures along with JCPDS Card #35-0816 patterns.

FIG. 2 illustrates XRD patterns of MgF₂ nanostructures along with JCPDS Card #41-1443 patterns.

FIG. 3 illustrates an SEM image of CaF₂ nanostructures.

FIG. 4 illustrates EDS patterns of CaF₂ nanostructures.

FIG. 5 illustrates an SEM image of MgF₂ nanostructures.

FIG. 6 illustrates EDS patterns of MgF₂ nanostructures.

FIG. 7 illustrates DSC-TGA curves of CaF₂ nanostructures prepared by the precipitation method.

FIG. 8 illustrates XRD patterns of CaF₂ nanostructures prepared by the hydrothermal method (Approach 1).

FIG. 9 illustrates an SEM image of CaF₂ nanostructures prepared by the hydrothermal method (Approach 1).

FIG. 10 illustrates EDS patterns of CaF₂ nanostructures prepared by the hydrothermal method (Approach 1).

FIG. 11 illustrates XRD patterns of CaF₂ nanostructures prepared by the hydrothermal method (Approach 2).

FIG. 12 illustrates an SEM image of CaF₂ nanostructures prepared by the hydrothermal method (Approach 2).

FIG. 13 illustrates EDS patterns of CaF₂ nanostructures prepared by the hydrothermal method (Approach 2).

FIG. 14 illustrates XRD patterns of CaF₂ nanostructures prepared by the hydrothermal method (Approach 3).

FIG. 15 illustrates an SEM image of CaF₂ nanostructures prepared by the hydrothermal method (Approach 3).

FIG. 16 illustrates EDS patterns of CaF₂ nanostructures prepared by the hydrothermal method (Approach 3).

FIG. 17 illustrates XRD patterns of CaF₂ nanostructures prepared by the wet-chemical method.

FIG. 18 illustrates an SEM image of CaF₂ nanostructures prepared by the wet-chemical method.

FIG. 19 illustrates EDS patterns of CaF₂ nanostructures prepared by the wet-chemical method.

FIG. 20 illustrates XRD patterns of MgF₂ nanostructures prepared by the wet-chemical method.

FIG. 21 illustrates an SEM image of MgF₂ nanostructures prepared by the wet-chemical method.

FIG. 22 illustrates EDS patterns of MgF₂ nanostructures prepared by the wet-chemical method.

FIG. 23 illustrates XRD patterns of CaF₂ nanostructures prepared by the combustion method (thioacetamide as fuel).

FIG. 24 illustrates an SEM image of CaF₂ nanostructures prepared by the combustion method (thioacetamide as fuel).

FIG. 25 illustrates EDS patterns of CaF₂ nanostructures prepared by the combustion method (thioacetamide as fuel).

FIG. 26 illustrates XRD patterns of CaF₂ nanostructures prepared by the combustion method (glycine as fuel).

FIG. 27 illustrates DSC-TGA curves of CaF₂ nanostructures prepared by the combustion method (glycine as fuel).

FIG. 28 illustrates an SEM image of CaF₂ nanostructures prepared by the combustion method (glycine as fuel).

FIG. 29 illustrates EDS patterns of CaF₂ nanostructures prepared by the combustion method (glycine as fuel).

FIG. 30 illustrates XRD patterns of MgF₂ nanostructures prepared by the combustion method.

FIG. 31 illustrates XRD patterns of CaF₂-MgF₂ nanostructures prepared by the precipitation method.

FIG. 32 illustrates an SEM image of CaF₂-MgF₂ nanostructures prepared by the precipitation method.

FIG. 33 illustrates EDS patterns of CaF₂-MgF₂ nanostructures prepared by the precipitation method.

FIG. 34 illustrates DSC-TGA curves of CaF₂-MgF₂ nanocomposites synthesized by the solid-state method.

FIG. 35 illustrates XRD patterns of CaF₂-MgF₂ nanostructures prepared by the solid-state method.

FIG. 36 illustrates an SEM image of CaF₂-MgF₂ nanostructures prepared by the solid-state method.

FIG. 37 illustrates EDS patterns of CaF₂-MgF₂ nanostructures prepared by the solid-state method.

FIG. 38 illustrates XRD patterns of CaF₂-MgF₂ nanostructures prepared by the precipitation method.

FIG. 39 illustrates an SEM image of CaF₂-MgF₂ nanostructures prepared by the precipitation method.

FIG. 40 illustrates EDS patterns of CaF₂-MgF₂ nanostructures prepared by the precipitation method.

FIG. 41 illustrates XRD patterns of CaF₂-MgF₂ nanostructures prepared by the combustion method (glycine as fuel).

FIG. 42 illustrates an SEM image of CaF₂-MgF₂ nanostructures prepared by the combustion method (glycine as fuel).

FIG. 43 illustrates EDS patterns of CaF₂-MgF₂ nanostructures prepared by the combustion method (glycine as fuel).

FIG. 44A shows a SEM micrograph of ceramic microstructures of CaF₂, FIG. 44B shows a SEM micrograph of MgF₂ disk, and FIG. 44C shows a SEM micrograph of ceramic microstructures of CaF2/MgF2 composite disk.

FIG. 45 illustrates the optical transmittance spectrum of a disk specimen sintered by hot pressing using CaF₂ (WC) powder at 900 °C for 2 hours under a pressure of 50 MPa, and subsequently polished to a 1 mm thickness.

FIG. 46 illustrates the optical transmittance spectrum of a disk specimen sintered by hot pressing using MgF₂ (WC) powder at 750 °C for 2 hours under a pressure of 40 MPa, and subsequently polished to a 1 mm thickness.

FIG. 47 illustrates the optical transmittance spectrum of a disk specimen sintered by hot pressing using CaMgF₂ (SS) powder at 700 °C for 2 hours under a pressure of 45 MPa, and subsequently polished to a 1 mm thickness.

FIG. 48 illustrates the optical transmittance spectrum of a disk specimen sintered by hot pressing using CaMgF₂ (PPT) powder at 700 °C for 2 hours under a pressure of 45 MPa, and subsequently polished to a 1 mm thickness.

FIG. 49 illustrates the optical transmittance spectrum of a disk specimen sintered by hot pressing using CaMgF₂ (SCG) powder at 700 °C for 2 hours under a pressure of 45 MPa, and subsequently polished to a 1 mm thickness.

### DETAILED DESCRIPTION

The subject matter of the present invention will now be described more fully with reference to the accompanying drawings, which form a part of this disclosure and illustrate specific exemplary embodiments. It should be understood, however, that the subject matter may be embodied in a variety of forms and is not limited to the embodiments set forth herein. The embodiments are provided by way of example to convey the scope of the invention, and the claimed subject matter should be construed broadly. By way of illustration, the subject matter may be embodied as methods, devices, components, or systems. Accordingly, the following detailed description is not intended to limit the invention.

As used herein, the term “exemplary” refers to an example, instance, or illustration. Any embodiment described as “exemplary” is not necessarily preferred or advantageous over other embodiments. Similarly, the expression “embodiments of the present invention” does not require that all embodiments include the particular feature, advantage, or mode of operation described.

The terminology used herein is for the purpose of describing particular embodiments only and is not intended to be limiting. As used in this specification, the singular forms “a,” “an,” and “the” include the plural forms unless the context clearly dictates otherwise. Furthermore, the terms “comprises,” “comprising,” “includes,” and “including,” when used herein, specify the presence of stated features, integers, steps, operations, elements, and/or components, but do not preclude the presence or addition of other features, integers, steps, operations, elements, components, and/or groups thereof.

The following detailed description sets forth the best currently contemplated modes of carrying out the invention. These descriptions are provided for purposes of illustration of the general principles of the invention. The scope of the invention, however, will be defined solely by the claims of any patent that may issue.

The present invention pertains to fluoride-based nanocomposites and methods of preparation thereof. The invention further relates to metal fluoride-based ceramics prepared from the fluoride-based nanocomposites.

In one aspect, a fabrication method is disclosed for fluoride-based nanocomposite ceramics comprising calcium fluoride (CaF₂) and magnesium fluoride (MgF₂). High-purity nanostructures of CaF₂ and MgF₂ may be synthesized via precipitation, hydrothermal, wet-chemical, and combustion routes. Multiple variants of CaF₂-MgF₂ nanocomposites may be prepared using solid-state, co-precipitation, and combustion techniques.

In another aspect, a method for controlled grain growth is disclosed, wherein MgF₂ is employed as a second-phase particle to suppress grain growth in CaF₂ through boundary pinning, thereby achieving finer and more uniform microstructures.

In a further aspect, a process is disclosed for preparing ceramic nanocomposites by spark plasma sintering (SPS) of fluoride-based nanocomposites. The disclosed SPS methods enable near-full densification (greater than 99.2%) of CaF₂ ceramics at elevated SPS temperatures. Optimization of the SPS process permits the preparation of fully dense and unbroken ceramic disks. The ceramic disks prepared from fluoride-based ceramics demonstrated high transparency in the mid-infrared (IR) range. Polished ceramic disks exhibited greater than 90% optical transmittance in the 3-9 μm spectral range, which is advantageous for IR window applications.

The ceramic disks prepared from fluoride-based ceramics demonstrated high transparency in the mid-infrared (IR) range. Polished ceramic disks exhibited greater than 90% optical transmittance in the 3-9 μm spectral range, which is advantageous for IR window applications.

The disclosed methods include a multi-scale densification strategy employing a combination of hot isostatic pressing (HIP), cold isostatic pressing (CIP), and hot pressing (HP) to fabricate robust and transparent ceramics. The process enables controlled microstructure development and minimizes porosity, thereby improving both optical transmission and mechanical durability.

The disks prepared from fluoride ceramics resulted in high transparency in mid IR range. Polished ceramic disks showed >90% optical transmittance in the 3-9 μm spectral range—vital for IR window applications. The disclosed method includes a multi-Scale densification strategy that includes a Combination of HIP, CIP, and Hot Press to fabricate robust, transparent ceramics with controlled microstructure and minimized porosity.

The disclosed methods enabled the preparation of controlled grain sizes, including approximately 2 μm in MgF₂, approximately 50 μm in CaF₂, and approximately 200-300 nm in MgF₂ when embedded in a CaF₂ matrix, thereby demonstrating advanced grain boundary engineering.

The methods further include the use of customized ceramic processing dies and coatings. Optimized boron nitride (BN) coatings and graphite tooling were adapted for different sintering platforms (e.g., hot pressing (HP) and spark plasma sintering (SPS)) to improve surface quality and facilitate demolding. Differential scanning calorimetry (DSC) and thermogravimetric analysis (TGA) were employed to characterize pyrolytic decomposition and sintering behavior, which are critical for refining thermal treatment steps and ensuring reproducibility of the fabrication process

In certain implementations, a cost-effective method is disclosed for producing CaF₂, MgF₂, and CaF₂-MgF₂ nanostructures at bulk scale, followed by densification. The resulting fluoride-based nanocomposites may be consolidated into high-transmission disks using hot pressing (HP), cold isostatic pressing (CIP), hot isostatic pressing (HIP), or spark plasma sintering (SPS). CaF₂ and MgF₂ nanostructures were synthesized using precipitation, wet-chemical, and combustion methods, yielding pure-phase materials as confirmed by X-ray diffraction (XRD) analysis. Scanning electron microscopy (SEM) images revealed highly clustered nanoparticles, with particle sizes ranging from approximately 50 nm to 1000 nm for wet-chemically synthesized powders. Significant hard agglomeration was observed after drying at 700 °C.

The composite CaF₂-MgF₂ powders demonstrated favorable phase dispersion, with coarse CaF₂ particles and finer MgF₂ particles. Such a distribution supports the formation of stable two-phase microstructures, which are advantageous for subsequent ceramic processing and densification.

In certain embodiments, CaF₂ nanostructures were synthesized via hydrothermal methods, while CaF₂-MgF₂ composites were prepared through precipitation, solid-state, and combustion techniques, with phase purity confirmed by XRD analysis. Spark Plasma Sintering (SPS) of CaF₂ powders conducted in the 600 °C to 1100 °C range demonstrated progressive densification, achieving relative densities exceeding 99.2% at elevated temperatures.

CaF₂, MgF₂, and CaF₂-MgF₂ disks sintered via cold isostatic pressing (CIP), hot pressing (HP), and hot isostatic pressing (HIP) methods, using wet-chemically synthesized powders (as-synthesized and vacuum-dried at 700 °C), remained intact during processing. Hot-press sintering of CaF₂ (wet-chemical method), MgF₂ (wet-chemical method), and CaF₂-MgF₂ composites (prepared via precipitation, combustion, or solid-state methods) produced well-densified ceramic disks. Polished disks with a thickness of approximately 1 mm exhibited optical transmittance exceeding 90% in the 3-9 μm spectral range.

### EXPERIMENTAL

### Example 1: Synthesis of CaF₂ Nanostructures by Precipitation Method

Ultra-fine calcium fluoride (CaF₂) nanopowders were synthesized using a chemical precipitation technique. One mole of calcium nitrate tetrahydrate (Ca(NO₃)₂·4H₂O; 118.075 g) was dissolved in 500 mL of distilled water to prepare a calcium precursor solution. Separately, one mole of ammonium fluoride (NH₄F; 18.5185 g) was dissolved in 500 mL of distilled water, and a few drops of ammonium hydroxide (NH₄OH) were added to adjust the pH to 8.0-11.0.

The calcium nitrate solution was then slowly added to the fluoride solution at a controlled rate of 10 mL/min, followed by the addition of 30 mL of NH₄OH to maintain the pH within the range of 8.0-11.0. The resulting mixture was stirred continuously for 60 minutes and subsequently aged for 12 hours. After aging, the clear supernatant was decanted, and the remaining precipitate was stirred for an additional 30 minutes.

The precipitate was washed four times with distilled water and twice with ethanol, using centrifugation at 3000 rpm for 10 minutes per wash. The cleaned powders were then dried at 90 °C for 24 hours. To reduce agglomeration, the dried powders were ball-milled with 5 mm yttria-stabilized zirconia (YSZ) balls in anhydrous alcohol for 48 hours. Finally, the resulting nanopowders were calcined at 500 °C for 5 hours at a heating rate of 2 °C/min prior to further use.

### Example 2: Synthesis of CaF₂ Nanostructures by Hydrothermal Method

In a typical synthesis procedure, 0.8878 g of calcium chloride dihydrate (CaCl₂·2H₂O) was dissolved in 20 mL of distilled water to prepare a calcium precursor solution. Subsequently, 40 mL of 1-butyl-3-methylimidazolium tetrafluoroborate ([BMIM]BF₄) with a concentration of 0.04 mol/L was added to the solution under continuous stirring for 20 minutes.

The pH of the resulting mixture was adjusted using ammonium hydrogen phosphate ((NH₄)₂HPO₄), after which the solution was transferred into a 100 mL Teflon-lined stainless-steel autoclave. The autoclave was sealed and heated at 180 °C for 24 hours in a laboratory oven to induce hydrothermal crystallization.

Upon completion, the autoclave was allowed to cool naturally to room temperature, and the white precipitate formed was collected by filtration, then washed several times with deionized water followed by ethanol rinsing to remove residual impurities. The purified product was dried in a vacuum oven at 60 °C for 24 hours and subsequently stored for further characterization and analysis.

### Example 3: Synthesis of Caf₂ Nanostructures by Hydrothermal Method

In a typical hydrothermal synthesis, 1.1332 g of calcium nitrate tetrahydrate (Ca(NO₃)₂·4H₂O) was dissolved in 32.00 mL of deionized water. The solution was subjected to ultrasonication for 10 minutes to ensure complete dissolution. Subsequently, 4.0 g of Pluronic P123 surfactant was added to the solution under continuous stirring until fully dissolved.

Thereafter, 40.00 mL of sodium tetrafluoroborate (NaBF₄) aqueous solution (0.4 M) was added, and the mixture was stirred vigorously for 30 minutes to obtain a homogeneous precursor solution. The pH of the solution was then adjusted to 11.0 by adding 2 mL of ammonium hydroxide (NH₄OH).

The final solution was transferred into a Teflon-lined stainless-steel autoclave, sealed, and heated at 180 °C for 24 hours in an oven to facilitate hydrothermal crystallization. After completion, the autoclave was cooled naturally to room temperature, and the precipitated product was collected by centrifugation, followed by repeated washing with deionized water and ethanol to remove residual ions and surfactant. The purified powders were then dried under vacuum at 60 °C for 24 hours and stored for subsequent analysis.

### Example 4: Synthesis of Caf₂ Nanostructures by Hydrothermal Method

In a representative hydrothermal synthesis procedure, 1.1332 g of calcium nitrate tetrahydrate (Ca(NO₃)₂·4H₂O) was dissolved in 32.00 mL of deionized water. The solution was subjected to ultrasonication for 10 minutes to ensure complete dissolution of the precursor. Subsequently, 4.0 g of sodium citrate surfactant was added to the solution and stirred until completely dissolved.

Next, 40.00 mL of sodium tetrafluoroborate (NaBF₄) aqueous solution (0.4 M) was added to the mixture, followed by vigorous stirring for 30 minutes to achieve a homogeneous precursor solution. The pH of the mixture was then adjusted to 11.0 by the addition of 2 mL of ammonium hydroxide (NH₄OH).

The resulting solution was transferred into a Teflon-lined stainless-steel autoclave, sealed, and heated at 180 °C for 24 hours in a laboratory oven to induce hydrothermal crystallization. After completion, the autoclave was allowed to cool naturally to room temperature, and the resulting white precipitate was separated by centrifugation, followed by repeated washing with deionized water and ethanol to remove residual surfactant and byproducts. The purified CaF₂ nanopowders were then dried under vacuum at 60 °C for 24 hours and stored for subsequent characterization.

### Example 5: Synthesis of CaF₂-MgF₂ Nanostructures by Precipitation Method

Calcium nitrate tetrahydrate (Ca(NO₃)₂·4H₂O) and magnesium nitrate hexahydrate (Mg(NO₃)₂·6H₂O) were used as precursor materials to prepare an aqueous mixed nitrate solution with a total metal ion concentration of 1 mol/L. To ensure that the occupied volume fractions of calcium fluoride and magnesium fluoride were equivalent in the subsequent ceramic composition, the mass ratio of magnesium nitrate to calcium nitrate was maintained at 1:0.73.

A separate ammonium fluoride (NH₄F) solution was prepared with an F⁻ ion concentration of 1 mol/L. The mixed nitrate solution was added dropwise to the fluoride solution at a controlled rate of 10 mL/min under continuous stirring. Upon completion of addition, the resulting suspension containing the mixed precipitate was stirred for an additional 1 hour, and the pH was adjusted to 10.8 using ammonium hydroxide (NH₄OH). The suspension was then aged for 3 hours at room temperature to ensure complete reaction and precipitation.

The precipitate was collected by centrifugation at 3000 rpm for 10 minutes, washed repeatedly with deionized water and ethanol, and centrifuged several times to remove residual fluoride and ammonium ions. The purified product was then dried at 60 °C for 24 hours. To minimize agglomeration, the dried powders were subjected to ball milling using 3 mm yttria-stabilized zirconia (YSZ) balls in anhydrous alcohol for 48 hours. Finally, the nanopowders were calcined at 500 °C for 5 hours at a heating rate of 2 °C/min, yielding fine CaF₂-MgF₂ nanocomposite powders suitable for densification and ceramic fabrication.

### Example 6: Synthesis of MgF₂ Nanostructures by Precipitation Method

Ultra-fine magnesium fluoride (MgF₂) nanopowders were synthesized using a chemical precipitation technique. One mole of magnesium nitrate hexahydrate (Mg(NO₃)₂·6H₂O; 128.205 g) was dissolved in 500 mL of distilled water to prepare a magnesium precursor solution. Separately, one mole of ammonium fluoride (NH₄F; 18.5185 g) was dissolved in 500 mL of distilled water, and several drops of ammonium hydroxide (NH₄OH) were added to adjust the pH to 8.0-11.0.

The magnesium nitrate solution was slowly added to the fluoride solution at a controlled rate of 10 mL/min under continuous stirring. After the addition was complete, 30 mL of NH₄OH was introduced to maintain the pH within 8.0-11.0, and the solution was stirred for 60 minutes. The resulting suspension was then aged for 12 hours, after which the clear supernatant was decanted, and the remaining mixture was stirred for an additional 30 minutes.

The precipitate was washed four times with distilled water and twice with ethanol, using centrifugation at 3000 rpm for 10 minutes during each wash cycle. The powders were subsequently dried at 90 °C for 24 hours. To reduce agglomeration, the dried powders were ball-milled using 5 mm yttria-stabilized zirconia (YSZ) balls in anhydrous alcohol for 48 hours. Finally, the nanopowders were calcined at 500 °C for 5 hours at a heating rate of 2 °C/min, producing fine MgF₂ nanopowders suitable for densification and further processing.

### Example 7: Wet-Chemical Synthesis of CaF₂ Nanostructures

Ultra-fine nanopowders of CaF₂ were produced via the wet-chemical method. 1 mole of Ca(NO₃)₂·4H₂O (118.075 g) was dissolved in 500 mL of distilled water. 1 mole of NH₄F (18.5185 g) was dissolved in 500 mL of distilled water and then added few drops of NH₄OH to set pH=8.0-11.0. Now the Calcium Nitrate solution was slowly (10 mL/min) added into the fluoride solution and then 30 ml NH₄OH solution was added to set pH=8.0-11.0 and then continued stirring for 15 min. The mixed solution was transferred into a 500 mL round-bottom flask and kept at 80 °C on a hot plate for 2 h to evaporate the solution. A bulky gel of high viscosity was obtained after slowly evaporating the solution at 80 °C by rotary evaporation. The obtained gel was heat treated at 120 °C for 24 h in an oven. The final product was then ground. A ball-milling process using 2 mm YSZ balls in anhydrous alcohol was applied for 48 h to break down large agglomerates of the nanopowders. Finally, after drying, the nanopowders were heated to 700 °C with a heating rate of 2 °C/min for 2 h before use.

### Example 8: Wet-Chemical Synthesis of MgF₂ Nanostructures

Ultra-fine magnesium fluoride (MgF₂) nanopowders were synthesized using a wet-chemical synthesis method. One mole of magnesium nitrate hexahydrate (Mg(NO₃)₂·6H₂O; 128.205 g) was dissolved in 500 mL of distilled water to form a magnesium precursor solution. Separately, one mole of ammonium fluoride (NH₄F; 18.5185 g) was dissolved in 500 mL of distilled water, and several drops of ammonium hydroxide (NH₄OH) were added to adjust the pH to 8.0-11.0.

The magnesium nitrate solution was gradually added to the fluoride solution at a controlled rate of 10 mL/min under constant stirring. Following the complete addition, 30 mL of NH₄OH was introduced to maintain the pH in the range of 8.0-11.0, and the reaction mixture was stirred for 15 minutes to ensure uniformity. The resulting solution was then transferred to a 500 mL round-bottom flask and maintained at 80 °C on a hot plate for 2 hours to facilitate slow solvent evaporation.

Upon evaporation, a high-viscosity gel was formed, which was subsequently heat-treated at 120 °C for 24 hours in a drying oven to remove residual moisture. The dried gel was then ground into fine powder. To minimize agglomeration and improve homogeneity, the powders were subjected to ball milling using 2 mm yttria-stabilized zirconia (YSZ) balls in anhydrous alcohol for 48 hours.

Finally, the obtained nanopowders were calcined at 700 °C for 2 hours with a heating rate of 2 °C/min, yielding high-purity MgF₂ nanostructures suitable for optical and structural characterization.

### Example 9: Synthesis of CaF₂ Nanostructures by Combustion Method

Ultra-fine calcium fluoride (CaF₂) nanostructures were synthesized in bulk quantity using a solution combustion method. One mole of calcium nitrate tetrahydrate (Ca(NO₃)₂·4H₂O; Alfa Aesar, 99.99%) was dissolved in 100 mL of distilled water to form a homogeneous precursor solution. To this solution, thioacetamide (CH₃CSNH₂; Alfa Aesar, ≥99%, ACS Reagent) was added as a fuel component, and the mixture was stirred for 5 minutes at 75 °C.

Separately, one mole of ammonium fluoride (NH₄F; 18.5185 g) was dissolved in 200 mL of distilled water to prepare the fluoride source. The fluoride solution was gradually added to the nitrate-thioacetamide mixture at a controlled rate of 10 mL/min, followed by continuous stirring for 60 minutes to ensure complete mixing and precursor homogeneity.

The resulting reaction mixture was then transferred into a preheated muffle furnace maintained at 500 °C and held for 40 minutes to initiate and sustain the combustion reaction. The self-sustaining exothermic process resulted in the rapid formation of fine CaF₂ powder. After cooling to room temperature, the combustion-derived product was ground using a mortar and pestle to break up any large aggregates.

To achieve uniform nanoscale dispersion, the powder was ball milled using 2 mm yttria-stabilized zirconia (YSZ) balls in anhydrous alcohol for 48 hours. Finally, the milled nanopowders were calcined at 700 °C for 4 hours with a heating rate of 5 °C/min, yielding high-purity CaF₂ nanostructures suitable for further use and characterization.

### Example 10: Synthesis of MgF₂ Nanostructures by Combustion Method

Ultra-fine magnesium fluoride (MgF₂) nanostructures were synthesized in bulk quantity using a solution combustion method. One mole of magnesium nitrate hexahydrate (Mg(NO₃)₂·6H₂O; Alfa Aesar, 99.99%) was dissolved in 100 mL of distilled water to form a homogeneous precursor solution. To this solution, thioacetamide (CH₃CSNH₂; Alfa Aesar, ≥99%, ACS Reagent) was added as a fuel component, and the mixture was stirred for 5 minutes at 75 °C.

Separately, one mole of ammonium fluoride (NH₄F; 18.5185 g) was dissolved in 200 mL of distilled water to prepare the fluoride source. The fluoride solution was gradually added to the nitrate-thioacetamide mixture at a controlled rate of 10 mL/min, followed by continuous stirring for 60 minutes to ensure homogeneity and complete precursor reaction.

The resulting reaction mixture was then transferred into a preheated muffle furnace maintained at 500 °C and held for 40 minutes, initiating a self-sustained combustion reaction that produced a fine MgF₂ powder. After cooling to ambient temperature, the combustion-derived product was ground using a mortar and pestle to reduce coarse aggregates.

The powder was subsequently ball milled using 2 mm yttria-stabilized zirconia (YSZ) balls in anhydrous alcohol for 48 hours to achieve uniform nanoscale dispersion. The nanopowders were then calcined at 700 °C for 4 hours with a heating rate of 5 °C/min, yielding high-purity MgF₂ nanostructures suitable for further densification and optical characterization.

### Example 11: Synthesis of CaF₂-MgF₂ Nanostructures by Combustion Method

Ultra-fine calcium fluoride-magnesium fluoride (CaF₂-MgF₂) nanostructures were synthesized in bulk quantity using a solution combustion method. One mole of magnesium nitrate hexahydrate (Mg(NO₃)₂·6H₂O; Alfa Aesar, 99.99%) and one mole of calcium nitrate tetrahydrate (Ca(NO₃)₂·4H₂O; Alfa Aesar, 99.99%) were dissolved in 200 mL of distilled water to form a homogeneous mixed nitrate solution.

To this solution, thioacetamide (CH₃CSNH₂; Alfa Aesar, ≥99%, ACS Reagent) was added as a fuel and complexing agent, and the mixture was stirred for 5 minutes at 75 °C. Separately, one mole of ammonium fluoride (NH₄F; 18.5185 g) was dissolved in 200 mL of distilled water to serve as the fluoride ion source. The fluoride solution was slowly added to the mixed nitrate-thioacetamide solution at a controlled rate of 10 mL/min, followed by continuous stirring for 60 minutes to ensure uniform precursor formation.

The resulting precursor mixture was then transferred into a preheated muffle furnace maintained at 500 °C and held for 40 minutes, during which a self-propagating combustion reaction occurred, producing a fine CaF₂-MgF₂ composite powder. After cooling to ambient temperature, the as-combusted product was manually ground using a mortar and pestle to reduce coarse aggregates.

The powder was subsequently ball milled using 2 mm yttria-stabilized zirconia (YSZ) balls in anhydrous alcohol for 48 hours to achieve homogeneous nanoscale dispersion. Finally, the nanopowders were calcined at 700 °C for 4 hours with a heating rate of 5 °C/min, yielding high-purity CaF₂-MgF₂ nanostructures suitable for further densification and optical applications.

### Example 12: Synthesis of CaF₂-MgF₂ Nanocomposite by Solid-State Reaction

A calcium fluoride-magnesium fluoride (CaF₂-MgF₂) nanocomposite was synthesized using a solid-state reaction method. Equal masses of CaF₂ nanostructures (10.20 g) and MgF₂ nanostructures (10.20 g)—each prepared previously by the wet-chemical method—were thoroughly mixed in a planetary ball mill for 48 hours using 2 mm yttria-stabilized zirconia (YSZ) balls as the milling medium and anhydrous ethanol as the dispersion solvent.

After milling, the mixed slurry was filtered using ethanol and the collected powder was dried in a vacuum oven at 60 °C for 12 hours to remove residual solvent. The resulting homogeneous powder blend was subsequently calcined at 700 °C for 4 hours with a controlled heating rate of 5 °C/min to promote solid-state reaction and phase homogeneity.

The obtained CaF₂-MgF₂ nanocomposite powder exhibited uniform grain morphology and was used for subsequent densification and infrared-transparent ceramic fabrication.

Powder X-ray diffraction (XRD, Brucker Advanced) analysis was carried out to analyze the crystalline phases of the synthesized powders. The morphologies of the nanopowders were characterized by field emission-scanning electron microscopy (FE-SEM, JEOL, Japan). Thermogravimetry analysis (TGA) was performed using a TGA 7(Perkin-Elmer) instrument analyzer to monitor the weight loss/gain and heat treatment processes under a flow of Nitrogen gas with a 10 °C/min heating rate. Measurements were carried out in the temperature range of 25≤T≤1000 °C. FTIR spectra was recorded from 2 μm-12 μm on sintered polished disks.

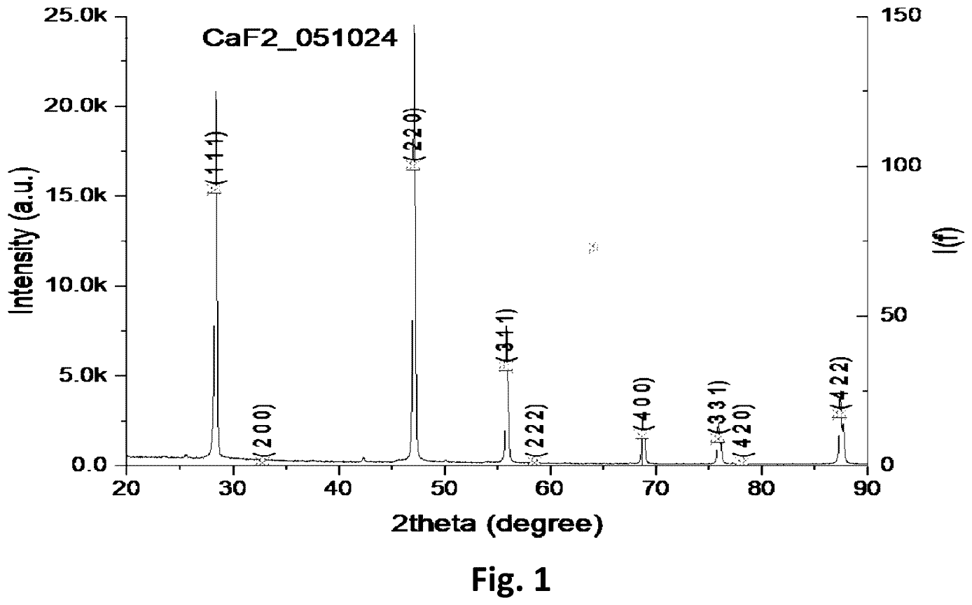

FIG. 1 shows XRD patterns of CaF₂ nanostructures. XRD patterns were indexed by using the JCPDS database (card no. 35-0816). The annealed at 500 °C nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature. It was interesting to mention that the peak intensity of the (2 2 0) reflection was much stronger than that of the standard powder diffraction pattern, suggesting its preferential growth along certain directions.

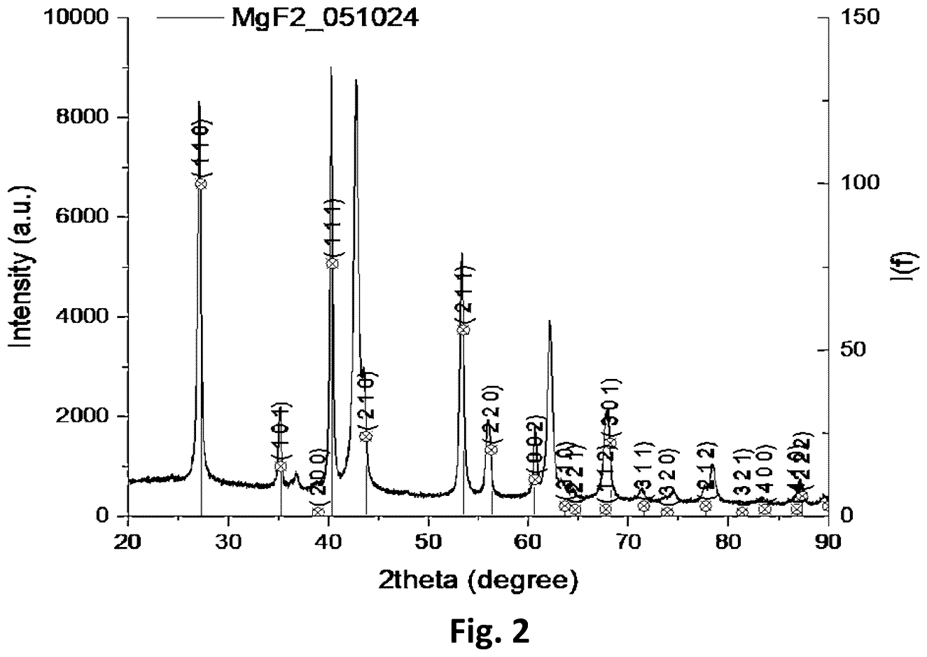

FIG. 2 shows XRD patterns of MgF₂ nanostructures. The location and intensity of reflections originating from MgF₂ sample corresponds to the data contained in the PDF database for magnesium fluoride (sellaite, JCPDS #41-1443). The annealed at 500 °C nanopowders was Tetragonal MgF₂ with the P42/mnm(136) space group. No characteristic peaks of impurities were detected, showing that MgF₂ was a pure phase.

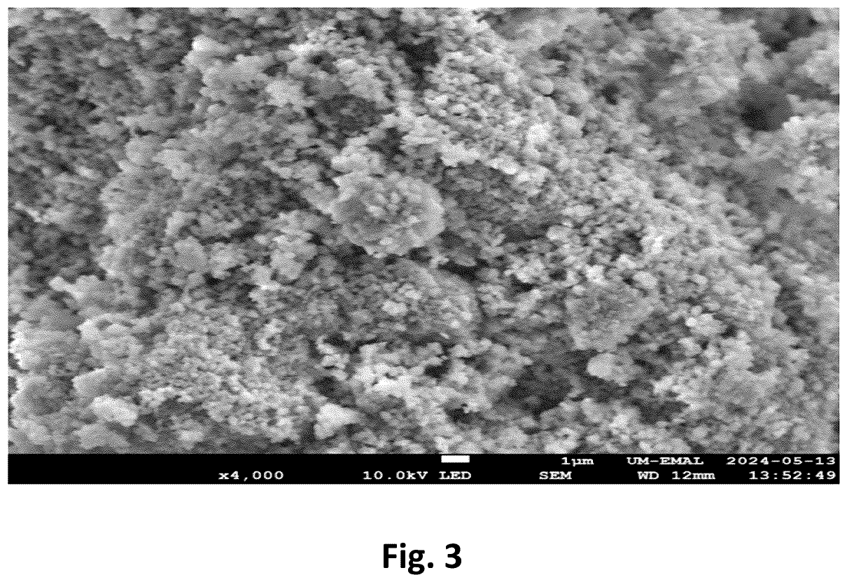

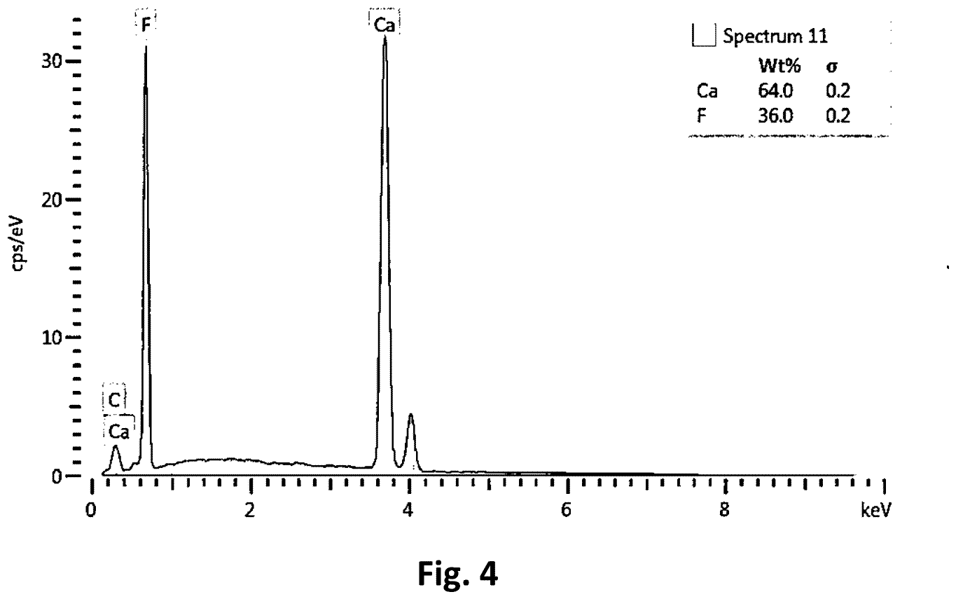

The SEM image of the CaF₂ nanostructures is Shown in FIG. 3. The CaF₂ nanostructures morphology results show the spherical shape of each particle. FIG. 4 shows EDS patterns of CaF₂ nanostructures. EDS results show the existence of Calcium and Fluoride elements only. Carbon comes from the substrate.

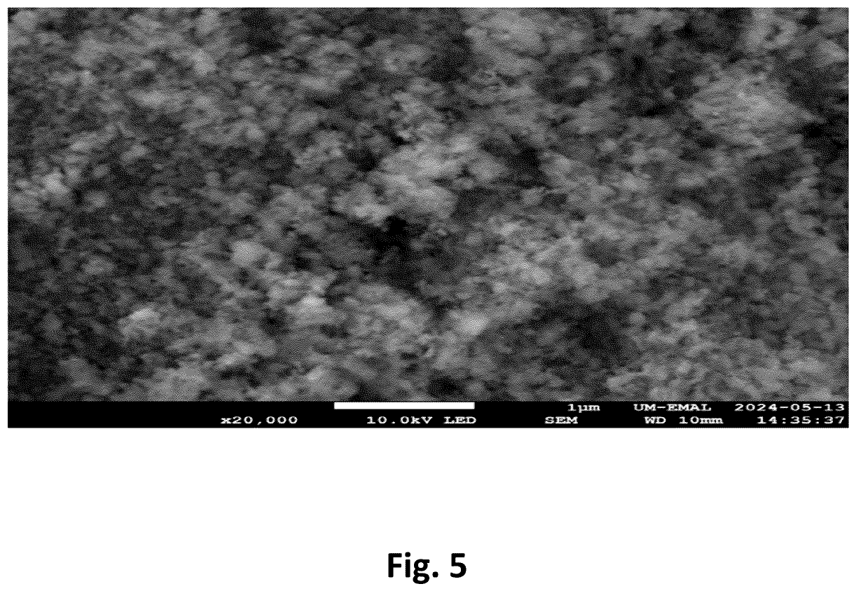

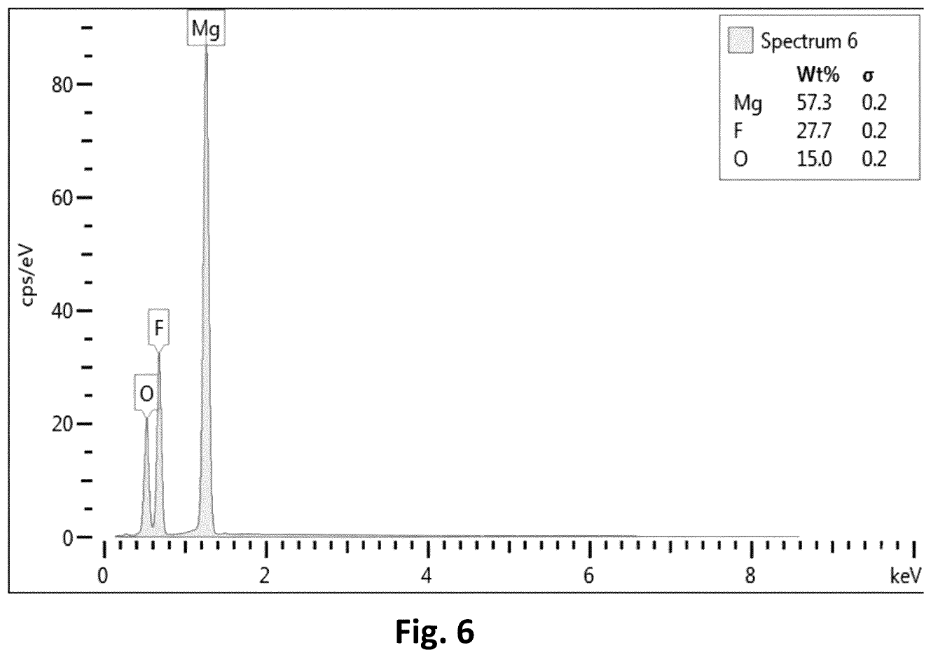

The SEM image of the MgF2 nanostructures is Shown in FIG. 5. The MgF₂ nanostructures morphology results show the spherical shape of each particle. FIG. 6 shows EDS patterns of MgF₂ nanostructures. EDS results show the existence of magnesium and Fluoride elements only. Oxygen comes from the chamber.

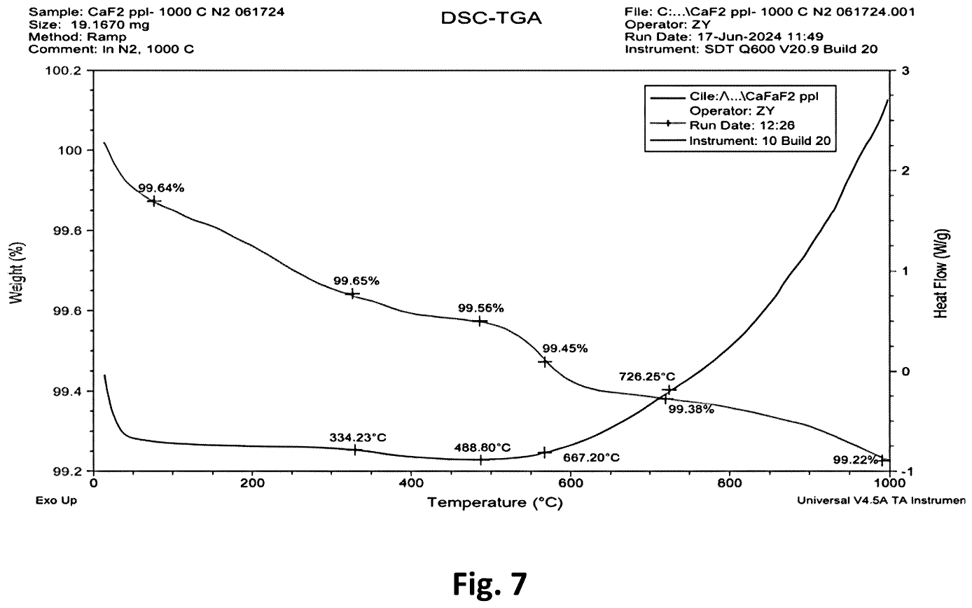

DSC-TGA curve of the synthesized (precipitation method) CaF₂ nanostructures annealed at 500 °C for 4 h is shown in FIG. 7. Pyrolytic decomposition of the metal (Ca) nitrate hydrate precursor proceeded in five steps. The total weight loss is 0.78% from room temperature to 1000 °C, which can be attributed to the decomposition of nitrates. The first weight loss is 0.36% from room temperature to 334.23 °C, which can be attributed to the decomposition of surface water and ammonia pieces.

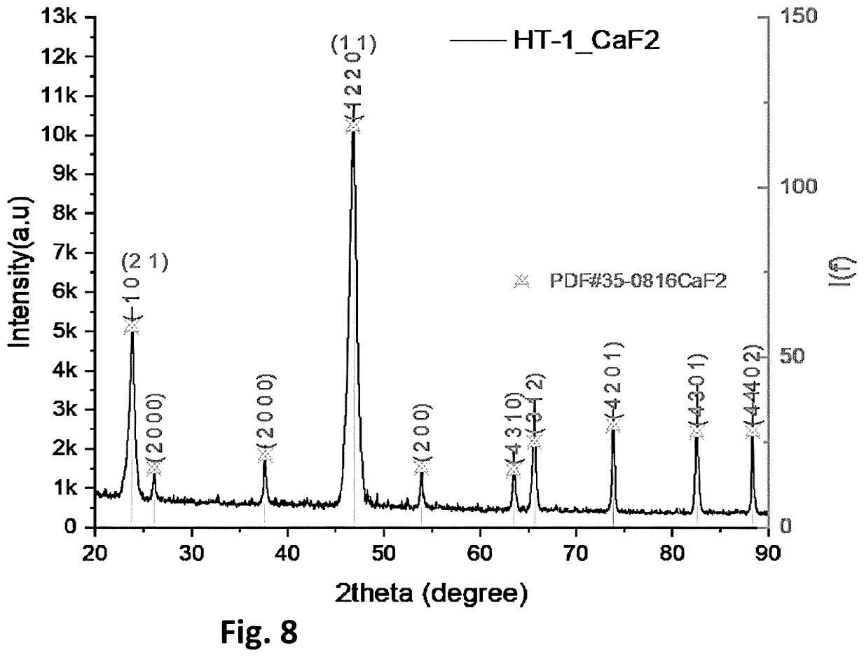

FIG. 8 shows XRD patterns of CaF₂ nanostructures prepared by hydrothermal method (approach 1). XRD patterns were indexed by using the JCPDS database (card no. 35-0816). As synthesized nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature.

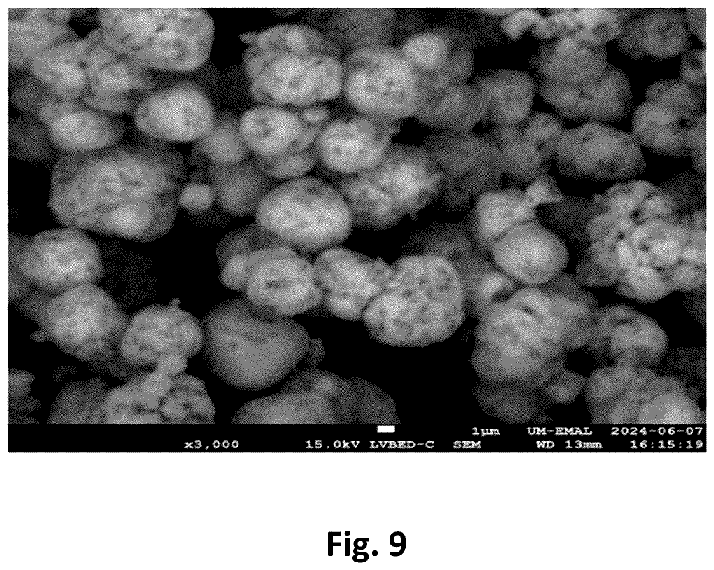

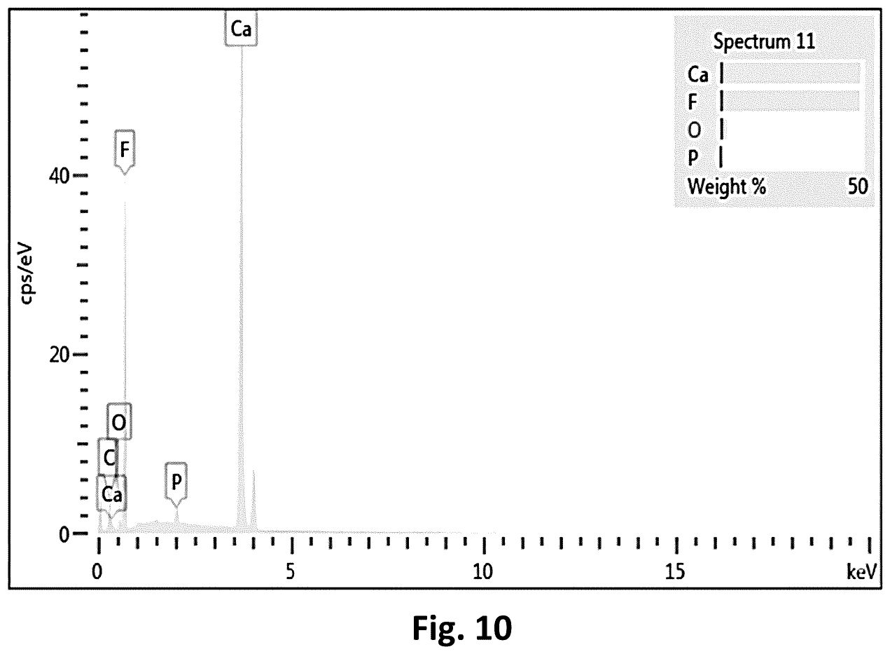

The SEM image of the CaF₂ nanostructures prepared by the hydrothermal method (approach 1) is shown in FIG. 9. The CaF₂ nanostructures morphology results show that spherical shape (bigger balls) of each particle. FIG. 10 shows EDS patterns of CaF₂ nanostructures. EDS results show the existence of Calcium and Fluoride elements. Carbon comes from the substrate, and the trace level of phosphorus might be from the pH-adjusting solution (NH₄)₂HPO₄. If we wash the precipitate a greater number of times, this phosphorus can get rid of it.

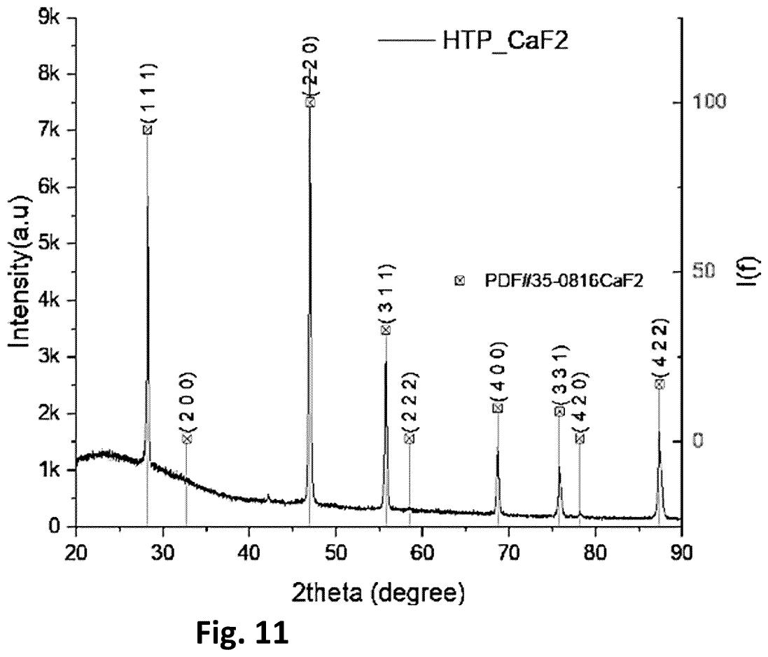

FIG. 11 shows XRD patterns of CaF₂ nanostructures prepared by hydrothermal method (approach 2). XRD patterns were indexed by using the JCPDS database (card no. 35-0816). As synthesized nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature.

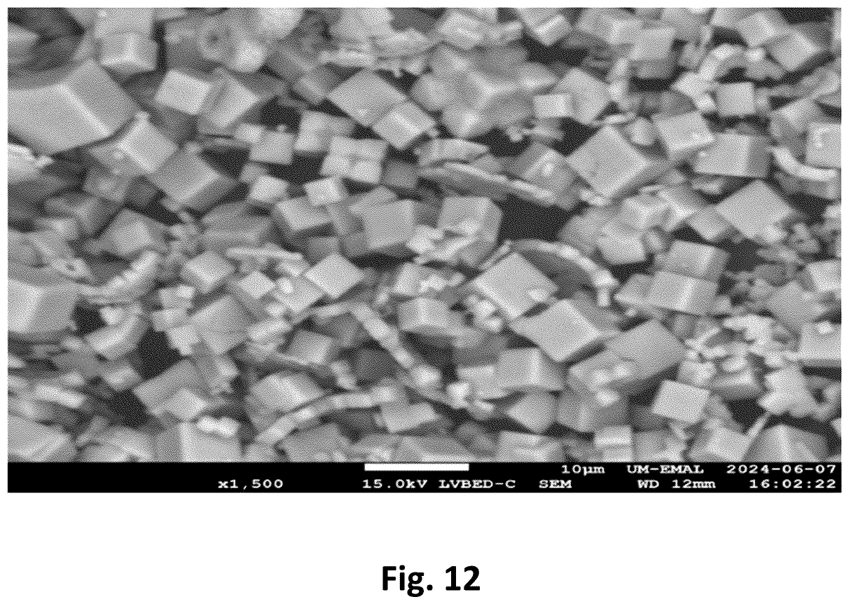

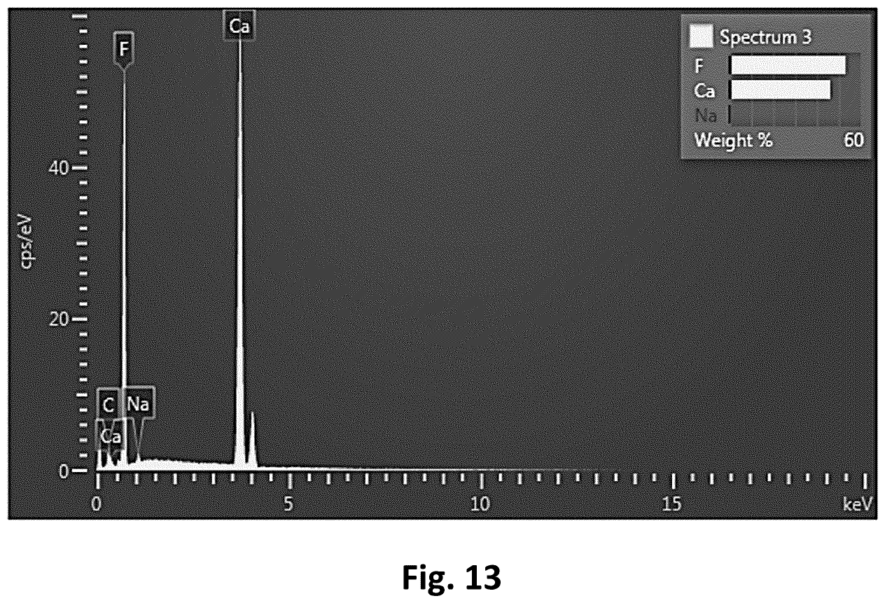

The SEM image of the CaF₂ nanostructures prepared by the hydrothermal method (approach 2) is shown in FIG. 12. The CaF₂ nanostructures morphology results show the cube shape of each particle. FIG. 13 shows EDS patterns of CaF₂ nanostructures. EDS results show the existence of Calcium and Fluoride elements. Carbon comes from the substrate, and the trace level of sodium might be from the glassware. If we wash the precipitate a greater number of times, this sodium can get rid of it.

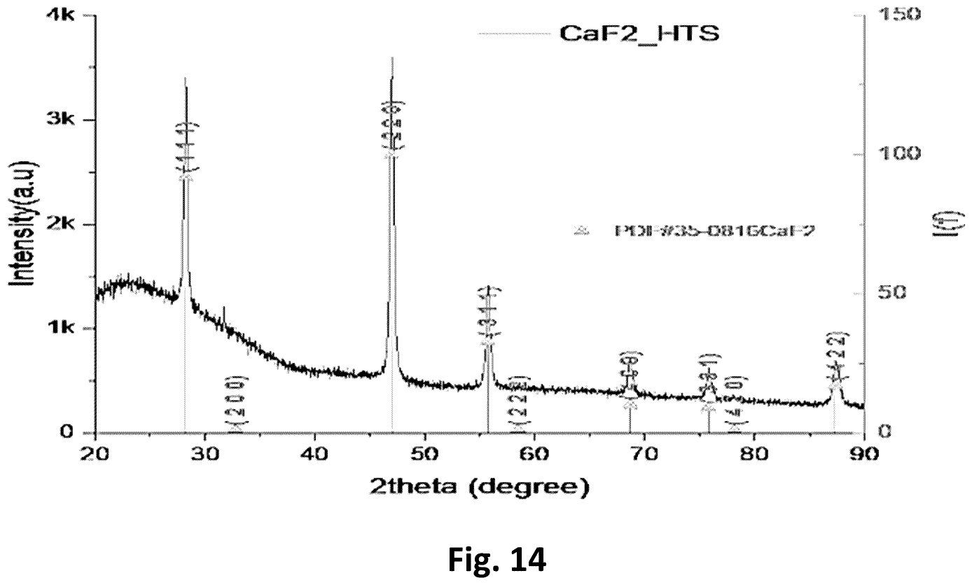

FIG. 14 shows XRD patterns of CaF₂ nanostructures prepared by hydrothermal method (approach 3). XRD patterns were indexed by using the JCPDS database (card no. 35-0816). As synthesized nanopowder was of cubic CaF₂ with the Fm-3m space group. No characteristic peaks of impurities were detected, showing that CaF2 was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature.

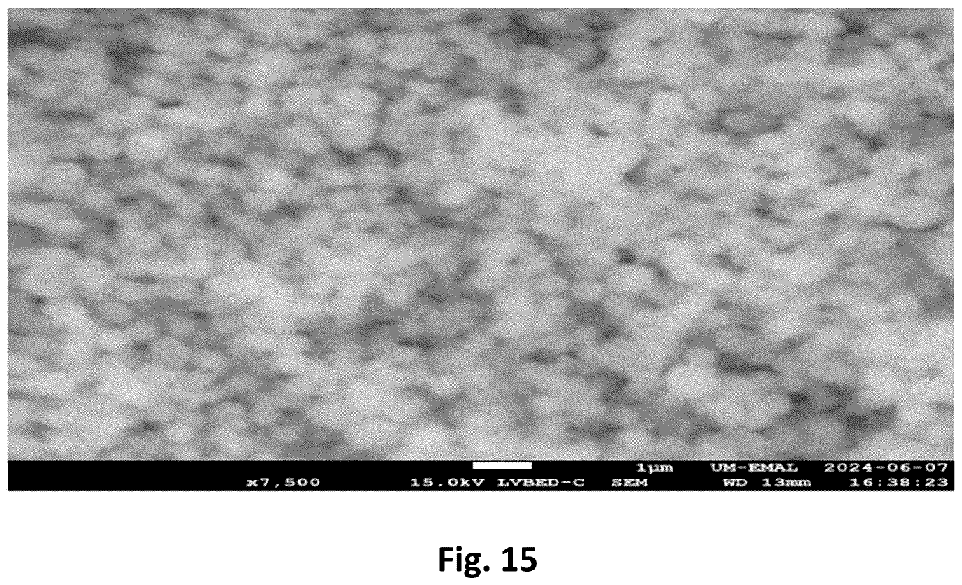

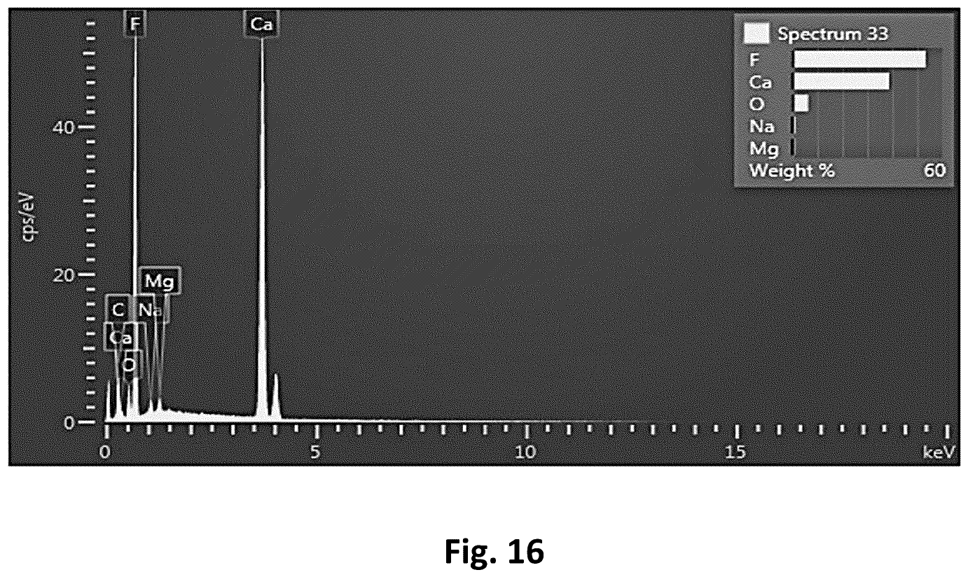

The SEM image of the CaF₂ nanostructures prepared by the hydrothermal method (approach 3) is shown in FIG. 15. The CaF₂ nanostructures morphology results show that monodispersed spheres shape each particle. FIG. 16 shows EDS patterns of CaF₂ nanostructures. EDS results show the existence of Calcium and Fluoride elements. Carbon comes from the substrate, and trace levels of sodium and Mg might be from the glassware. If we wash the precipitate a greater number of times, this sodium and Mg can get rid of it.

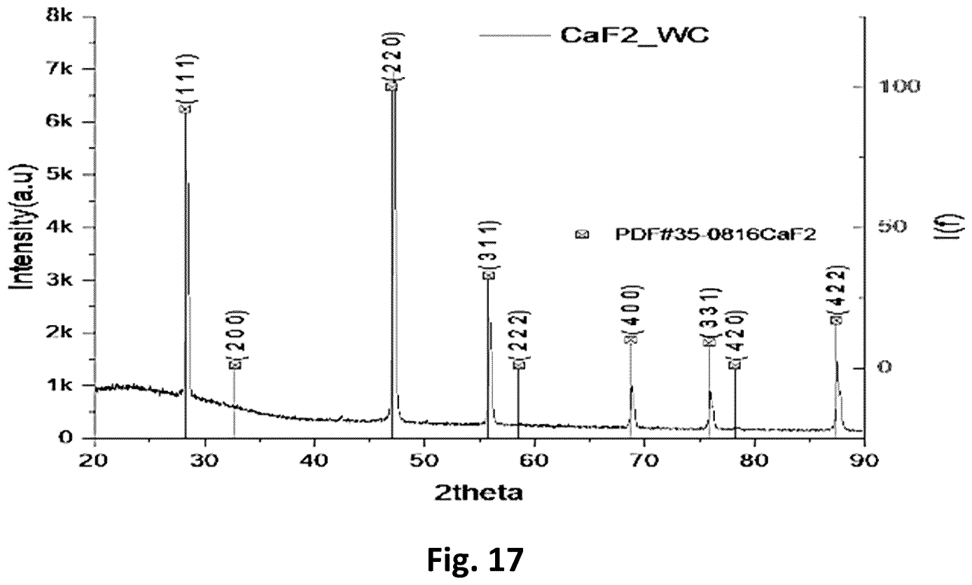

FIG. 17 shows XRD patterns of CaF₂ nanostructures prepared by the wet-chemical method. XRD patterns were indexed by using the JCPDS database (card no. 35-0816). As synthesized nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature.

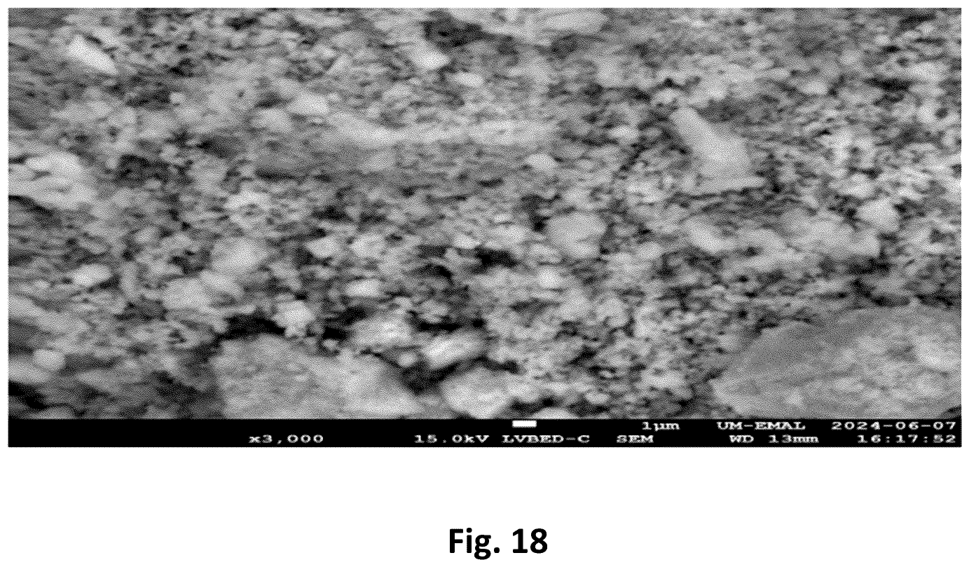

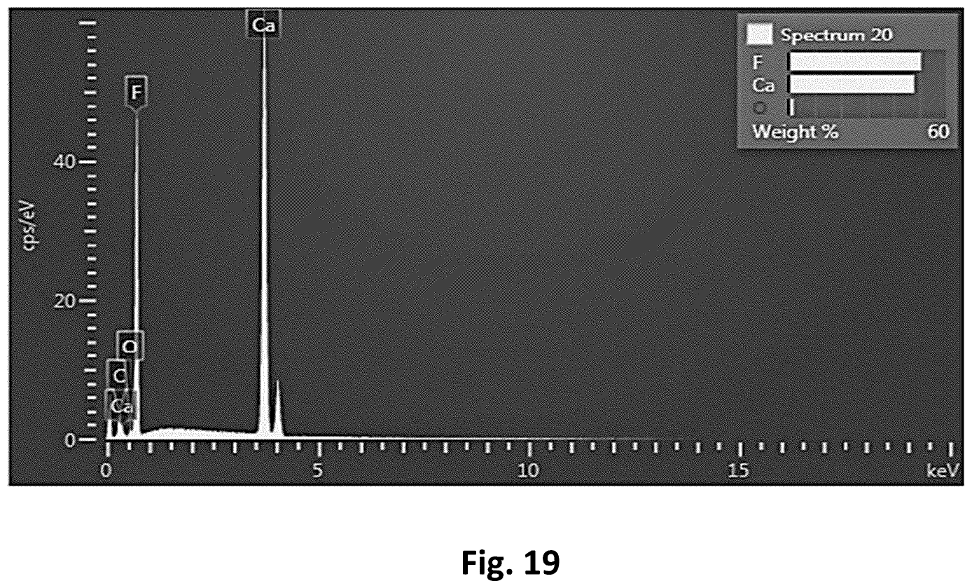

The SEM image of the CaF₂ nanostructures prepared by the wet-chemical method is shown in FIG. 18. The CaF₂ nanostructures morphology results show that spheres shape each particle. FIG. 17 shows EDS patterns of CaF₂ nanostructures. EDS results show the existence of Calcium and Fluoride elements. Carbon comes from the substrate and trace level oxygen from the SEM chamber.

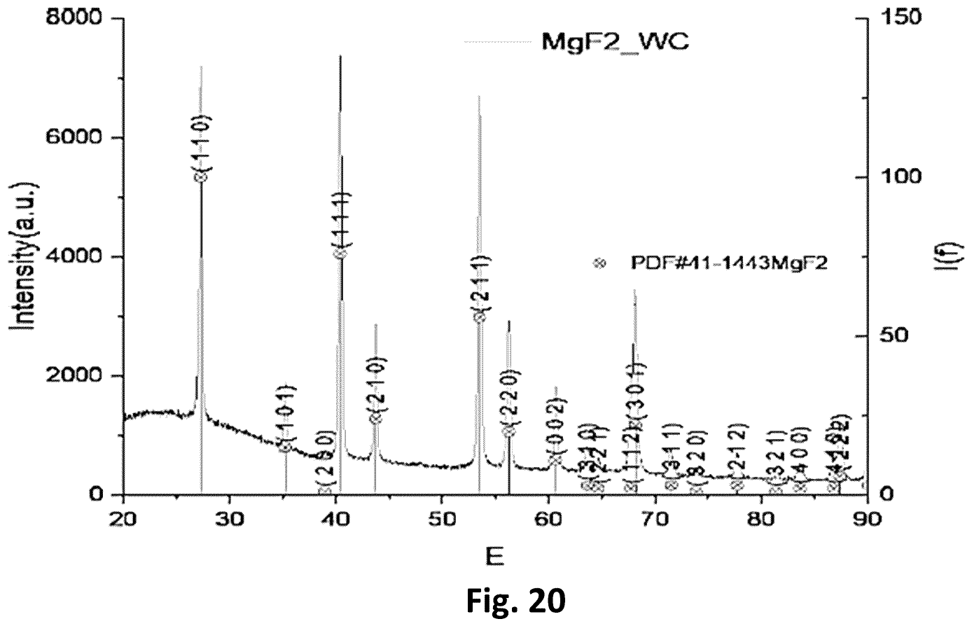

FIG. 20 shows XRD patterns of MgF₂ nanostructures prepared by the wet-chemical method. The location and intensity of reflections originating from MgF₂ sample corresponds to the data contained in the PDF database for magnesium fluoride (sellaite, JCPDS #41-1443). The annealed at 700 °C nanopowder was of Tetragonal MgF₂ with the P42/mnm(136) space group. No characteristic peaks of impurities were detected, showing that MgF₂ was a pure phase.

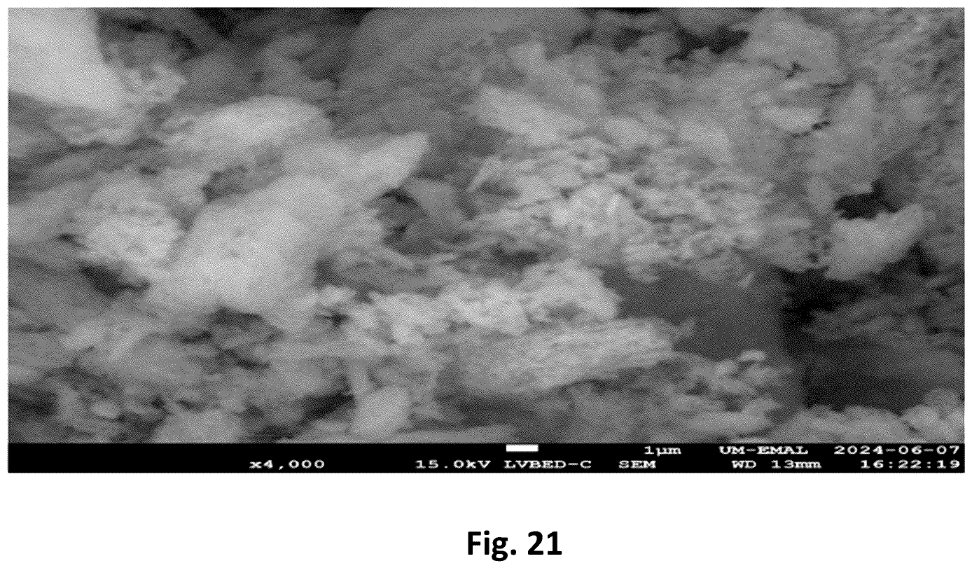

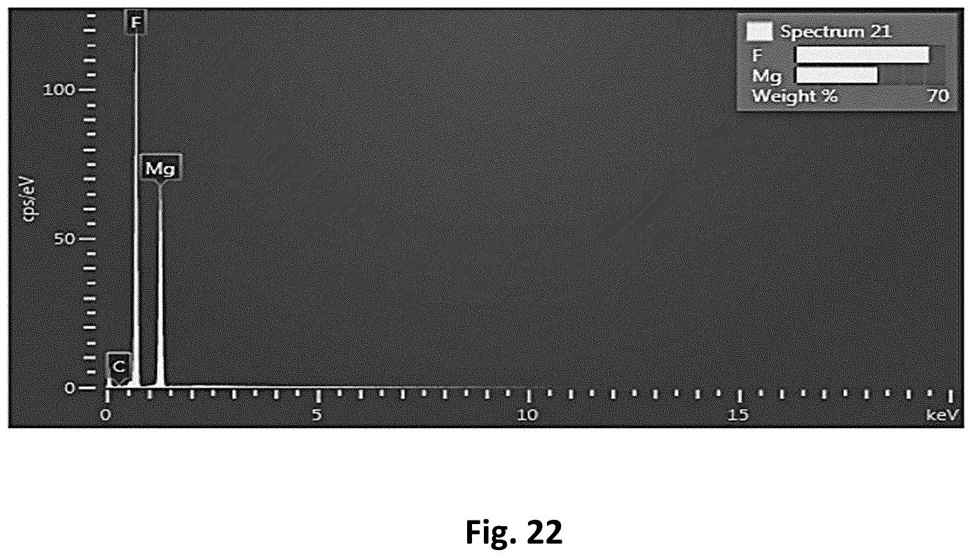

The SEM image of the MgF₂ nanostructures is Shown in FIG. 21. The MgF₂ nanostructures morphology results show the spherical shape of each particle. FIG. 22 shows EDS patterns of MgF₂ nanostructures. EDS results show the existence of magnesium and Fluoride elements only. Carbon comes from the substrate.

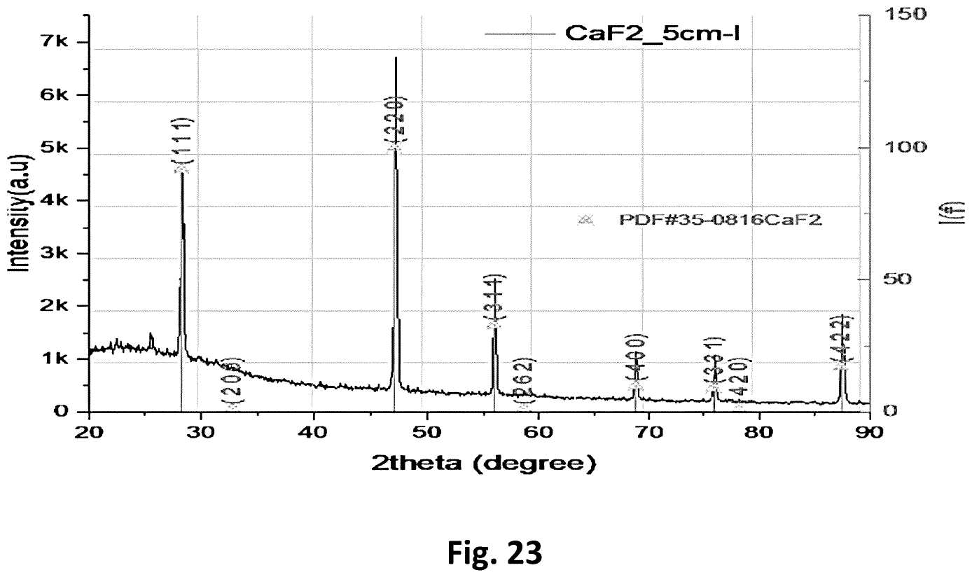

FIG. 23 shows XRD patterns of CaF₂ nanostructures prepared by the combustion method (Thioacetamide as a fuel). XRD patterns were indexed by using the JCPDS database (card no. 35-0816). As synthesized nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature.

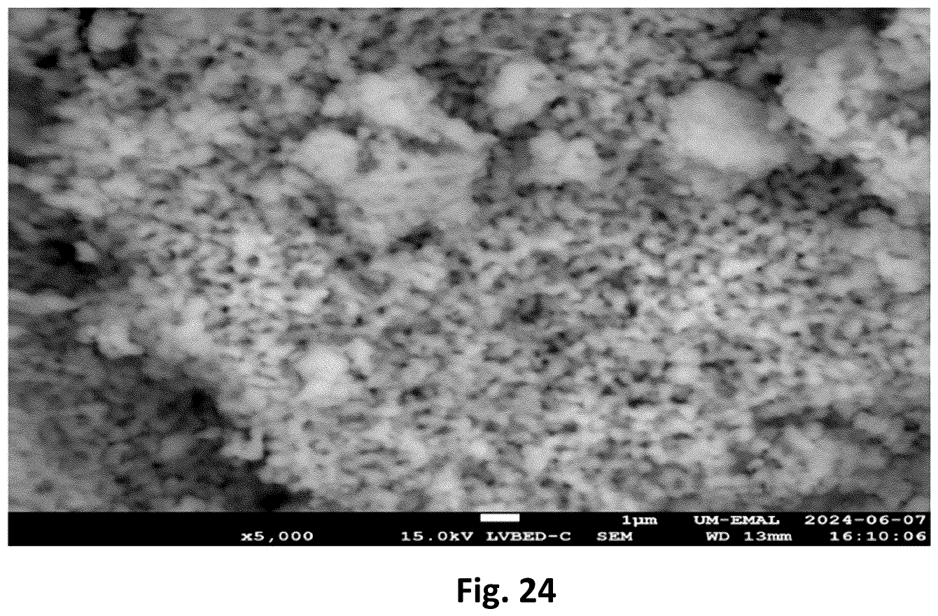

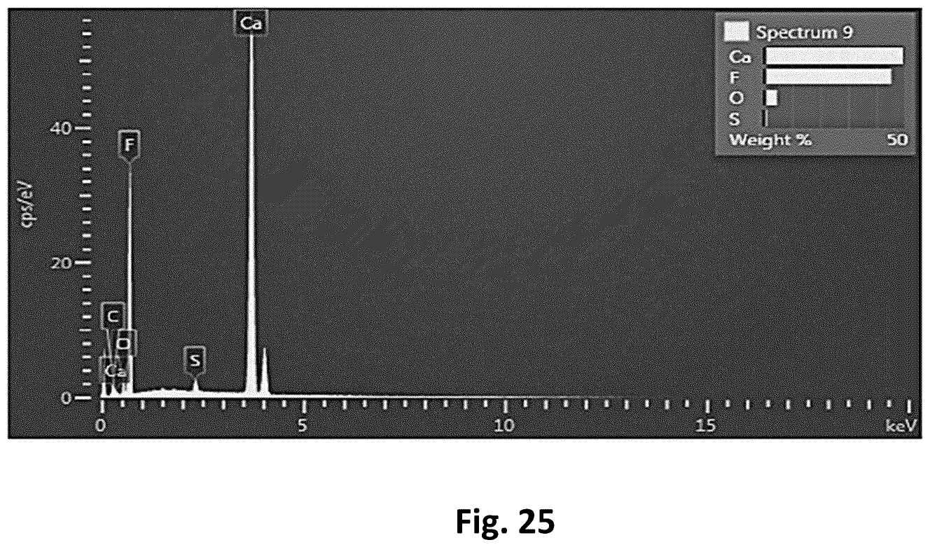

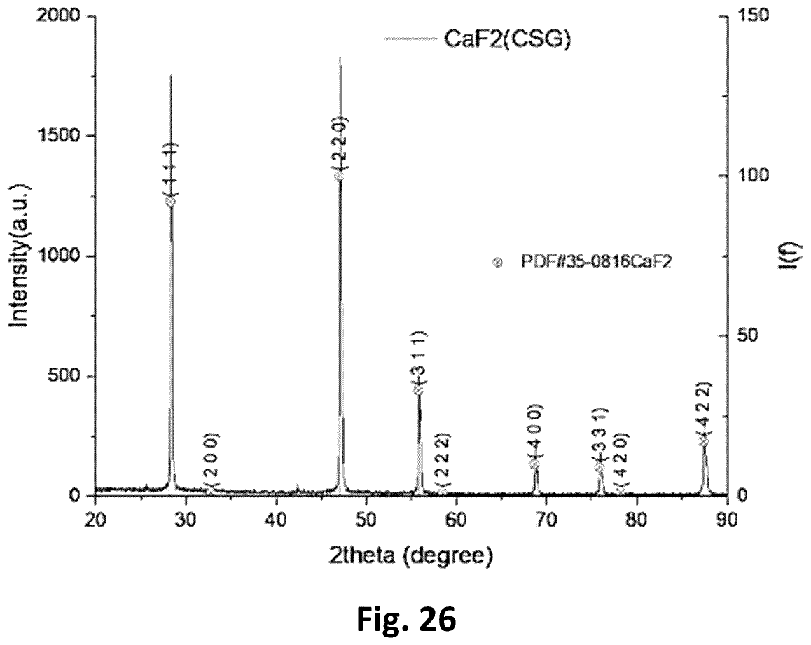

The SEM image of the CaF₂ nanostructures prepared by the combustion method (Thioacetamide as a fuel) is shown in FIG. 24. The CaF₂ nanostructures morphology results show that spheres shape each particle. FIG. 25 shows EDS patterns of CaF₂ nanostructures. EDS results show the existence of Calcium and Fluoride elements. Carbon comes from the substrate and trace level oxygen from the SEM chamber, and trace level of sulfur comes from the fuel. FIG. 26 shows XRD patterns of CaF₂ nanostructures prepared by the combustion method (Glycine as a fuel). XRD patterns were indexed by using the JCPDS database (card no. 35-0816). As synthesized nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature.

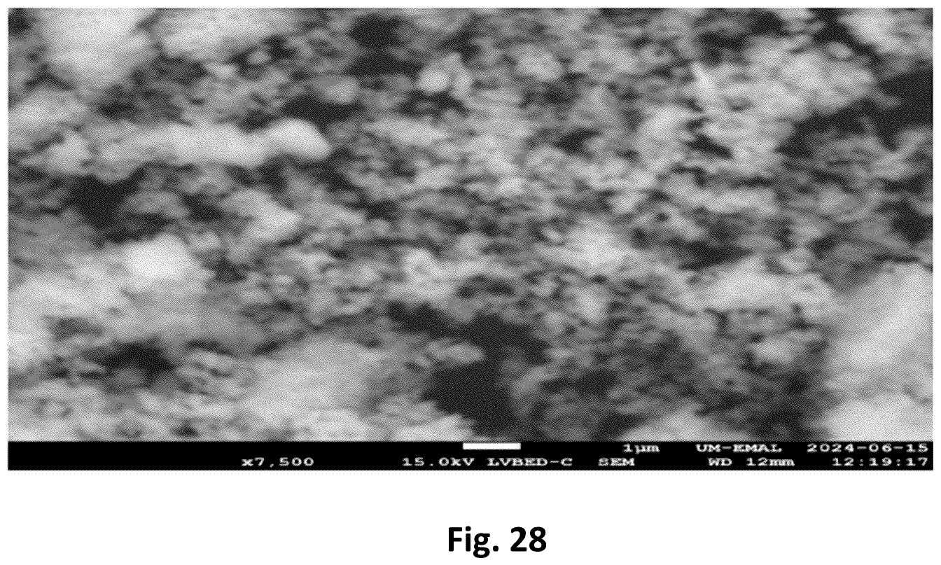

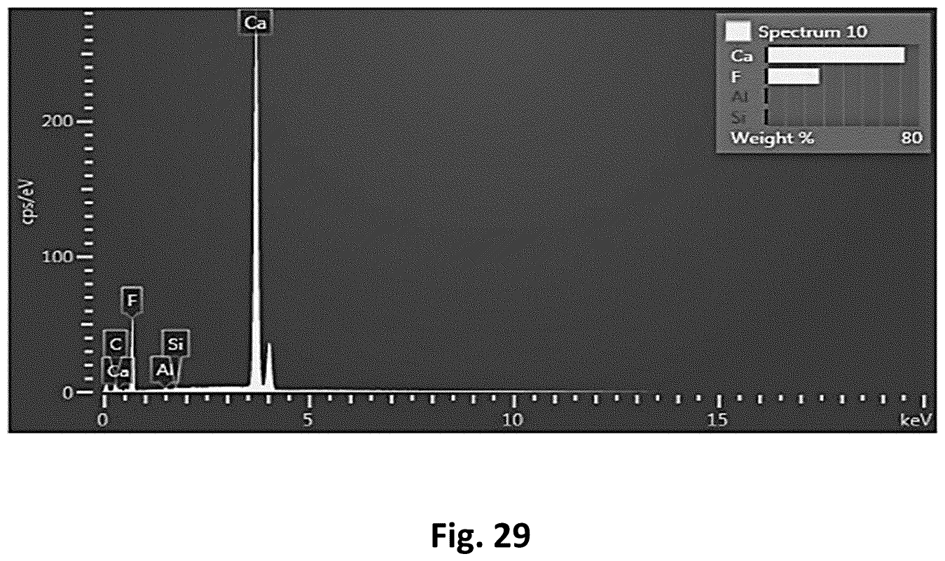

The SEM image of the CaF₂ nanostructures prepared by the combustion method (Glycine as a fuel) is shown in FIG. 28. The CaF₂ nanostructures morphology results show that spheres shape each particle. FIG. 29 shows EDS patterns of CaF₂ nanostructures. EDS results show the existence of Calcium and Fluoride elements. Carbon comes from the substrate, and trace level of Si, Al comes from the substrate.

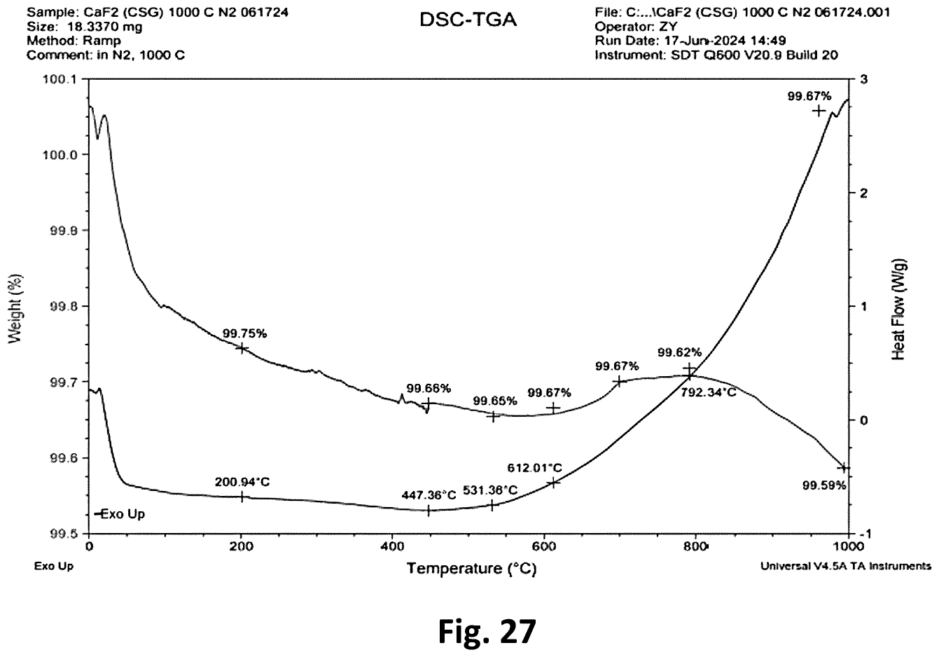

DSC-TGA curve of the synthesized (combustion method using glycine as a fuel) CaF₂ nanostructures annealed at 700 °C for 4 h is shown in FIG. 27. Pyrolytic decomposition of the metal (Ca) nitrate hydrate precursor proceeded in six steps. The total weight loss is 0.41% from room temperature to 1000 °C, which can be attributed to the decomposition of nitrates. The 1^{st} weight loss is 0.25% from room temperature to 200.94 °C, which can be attributed to the decomposition of surface water and ammonia pieces.

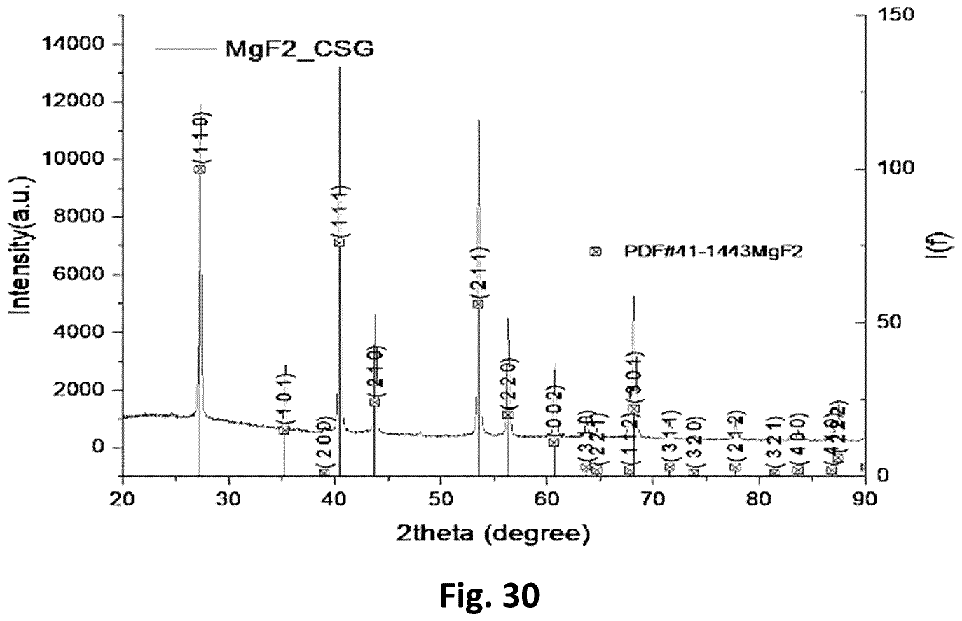

FIG. 30 shows XRD patterns of MgF₂ nanostructures synthesis by the combustion method (Glycine as a Fuel). The location and intensity of reflections originating from MgF₂ sample corresponds to the data contained in the PDF database for magnesium fluoride (sellaite, JCPDS #41-1443). The annealed at 700 °C nanopowder was of Tetragonal MgF₂ with the P42/mnm(136) space group. No characteristic peaks of impurities were detected, showing that MgF₂ was a pure phase.

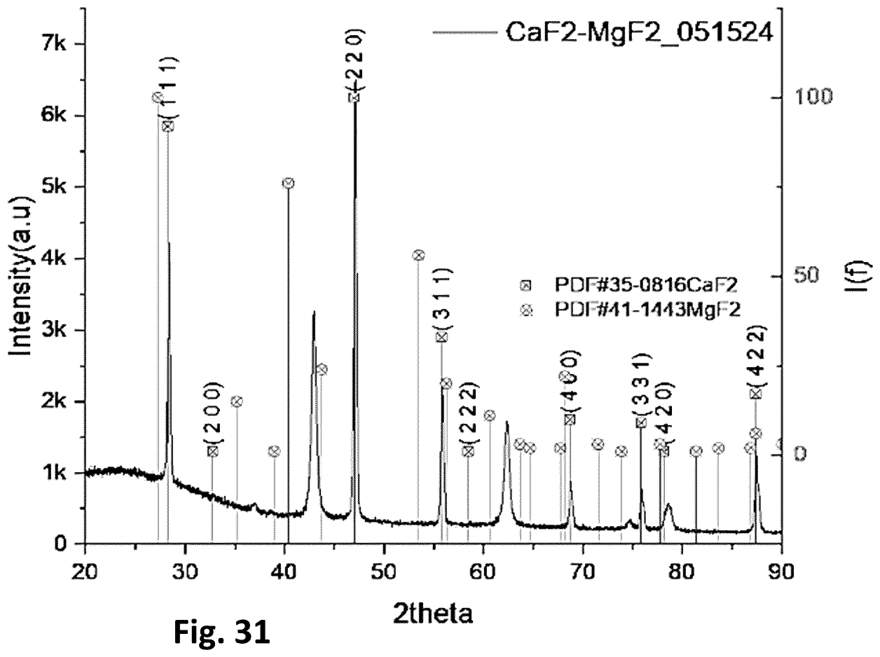

FIG. 31 shows XRD patterns of CaF₂-MgF₂ nanocomposite prepared by precipitation method. XRD patterns of CaF₂ were indexed by using the JCPDS database (card no. 35-0816). The annealed at 600 °C nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature, whereas very few diffraction peaks coincide with the MgF₂ database 41-1443, moreover, peak shift was also noticed, so going to repeat precipitation method in a different way to produce pure phase MgF₂ along with CaF₂ in MgF₂-CaF₂ nanocomposite.

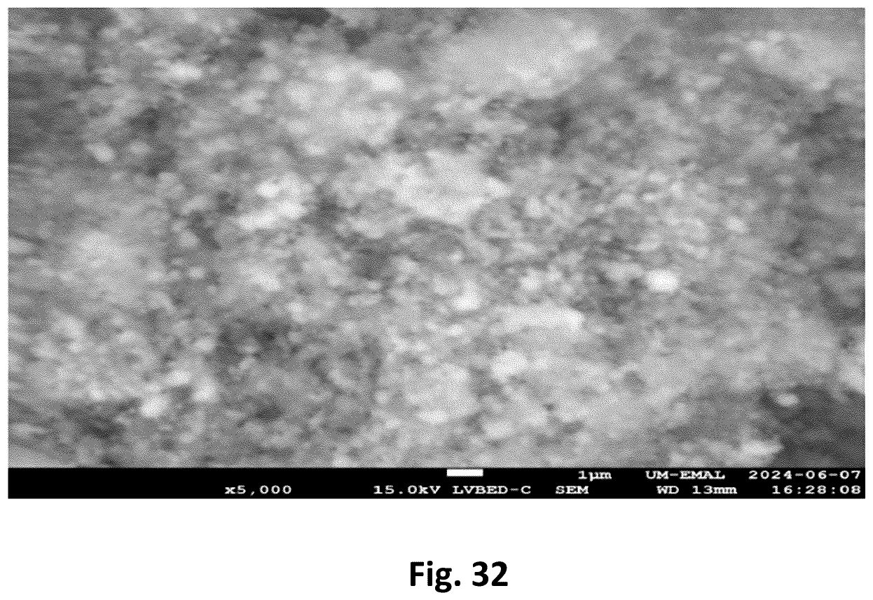

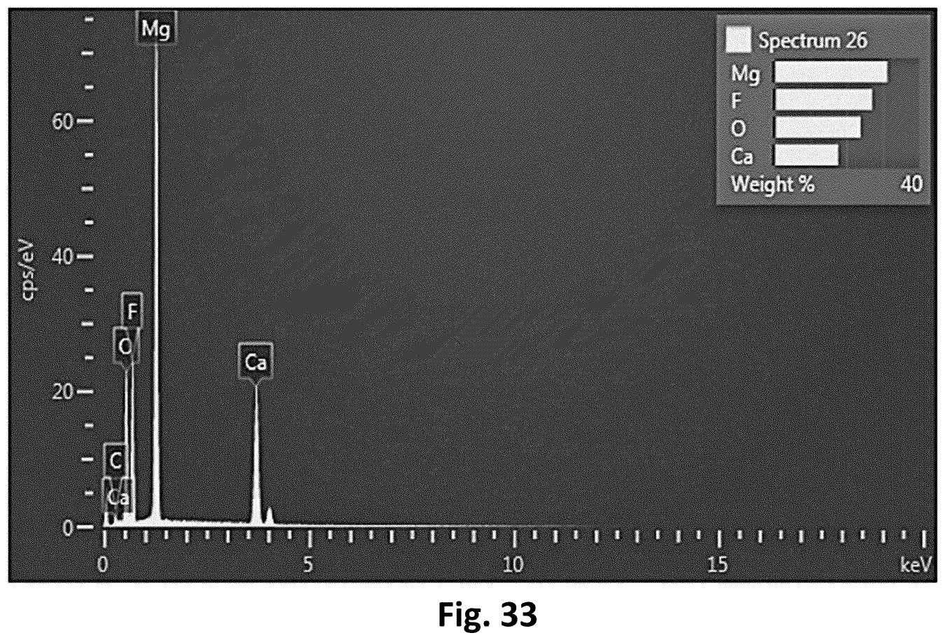

The SEM image of the CaF₂-MgF₂ nanocomposite prepared by the precipitation method is Shown in FIG. 32. The CaF₂-MgF₂ nanocomposite morphology results show that cloud of a tiny sphere shape of each particle. FIG. 33 shows EDS patterns of CaF₂-MgF₂ nanocomposite. EDS results show the existence of Calcium, magnesium, and Fluoride elements. Carbon comes from the substrate.

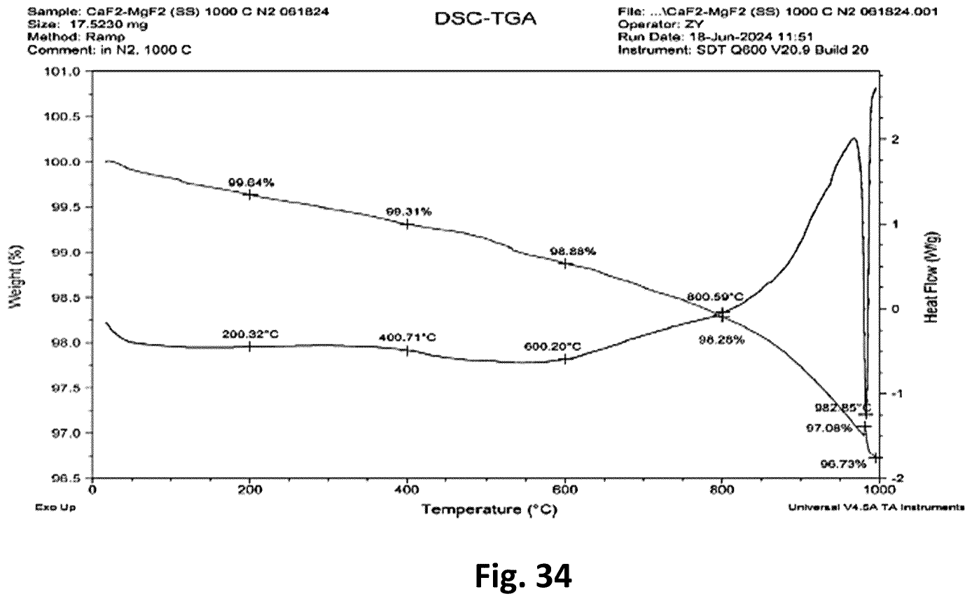

DSC-TGA curve of the synthesized (solid state method) CaF₂-MgF₂ nanocomposite dried at 60 °C for 12 h is shown in FIG. 34. Pyrolytic decomposition of the metal (Ca, Mg) nitrate hydrates precursor proceeded in five steps. The total weight loss is 3.27% from room temperature to 1000 °C, which can be attributed to the decomposition of nitrates. The first weight loss is 0.36% from room temperature to 200.32 °C, which can be attributed to the decomposition of surface water and ammonia pieces. One strong exothermic peak was observed at 982.85 °C. The endothermic peak precisely located the temperature of the eutectic point, as per the phase diagram of calcium fluoride and magnesium fluoride.

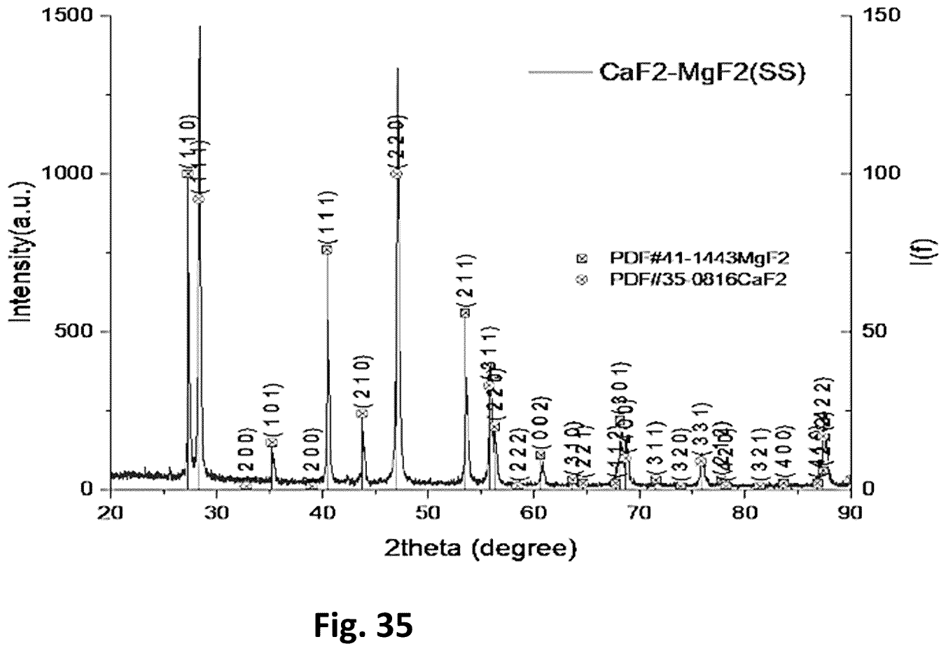

FIG. 35 shows XRD patterns of CaF₂-MgF₂ nanocomposite prepared by solid state method. The diffraction peaks of calcium fluoride and magnesium fluoride are clearly displayed in the XRD patterns. XRD patterns of CaF₂ were indexed by using the JCPDS database (card no. 35-0816). The annealed at 700 °C nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature. The location and intensity of reflections originating from MgF₂ sample corresponds to the data contained in the PDF database for magnesium fluoride (sellaite, JCPDS #41-1443). The annealed at 700 °C nanopowder was of Tetragonal MgF₂ with the P42/mnm(136) space group. No characteristic peaks of impurities were detected, showing that MgF₂ was a pure phase.

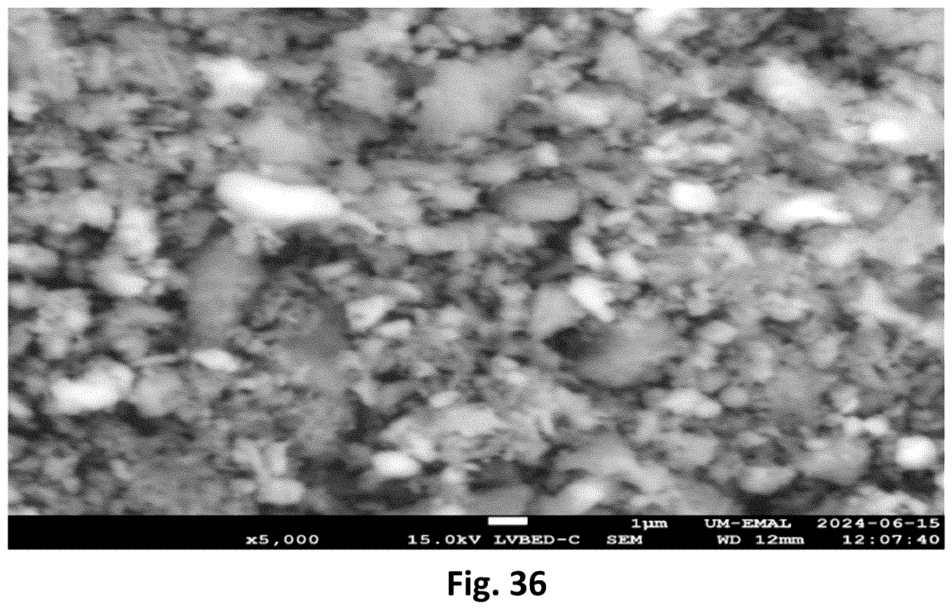

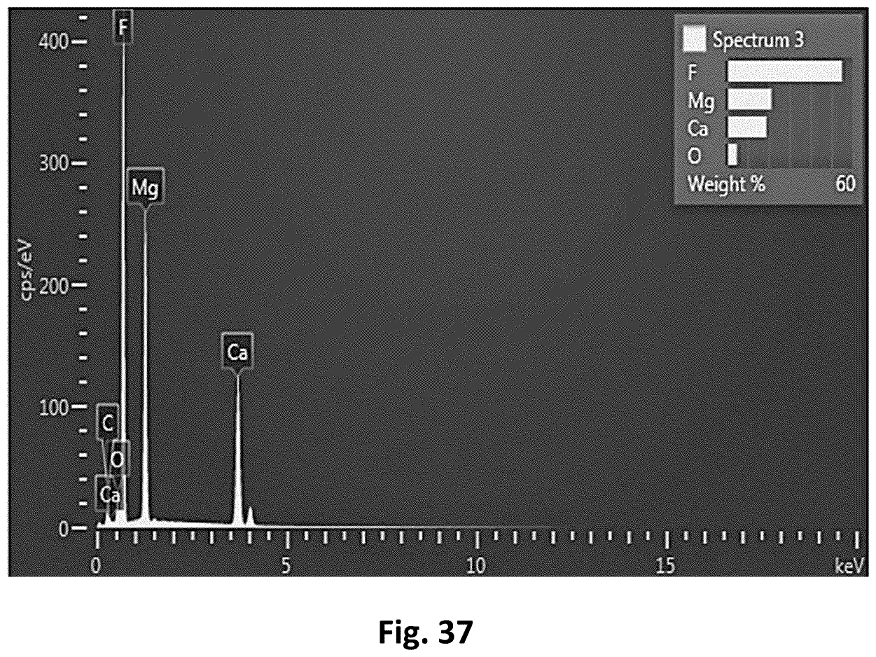

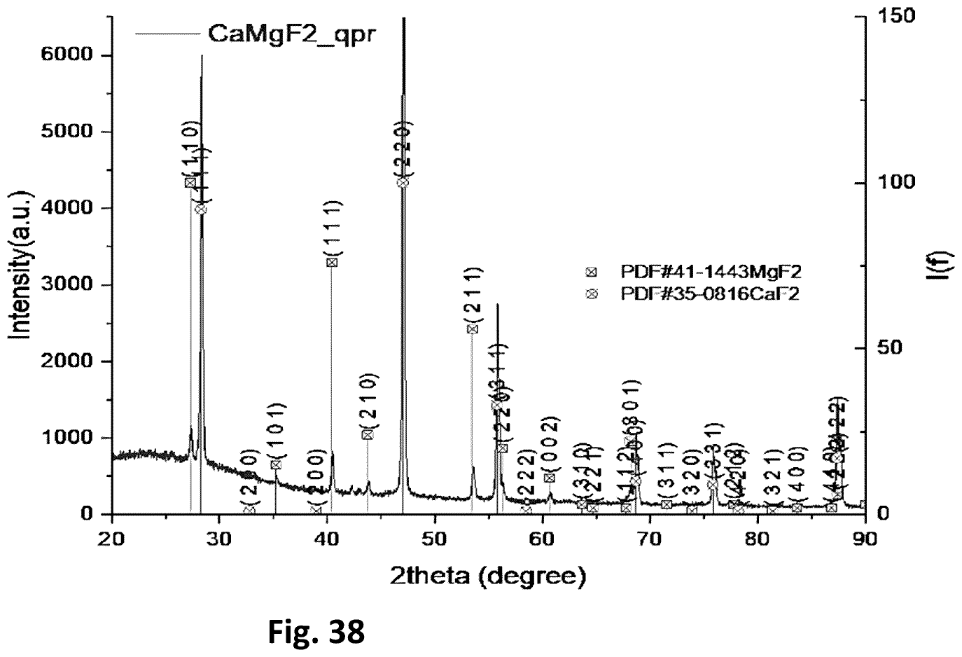

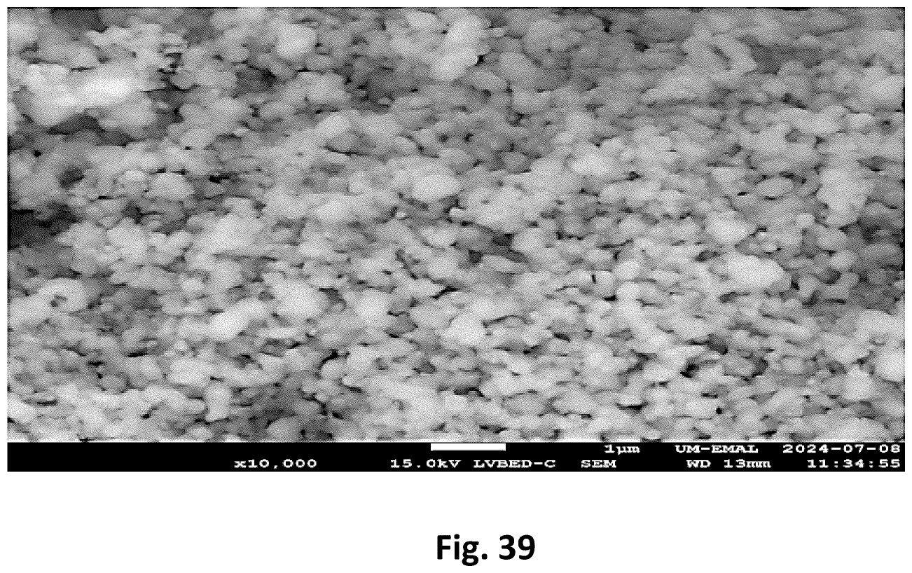

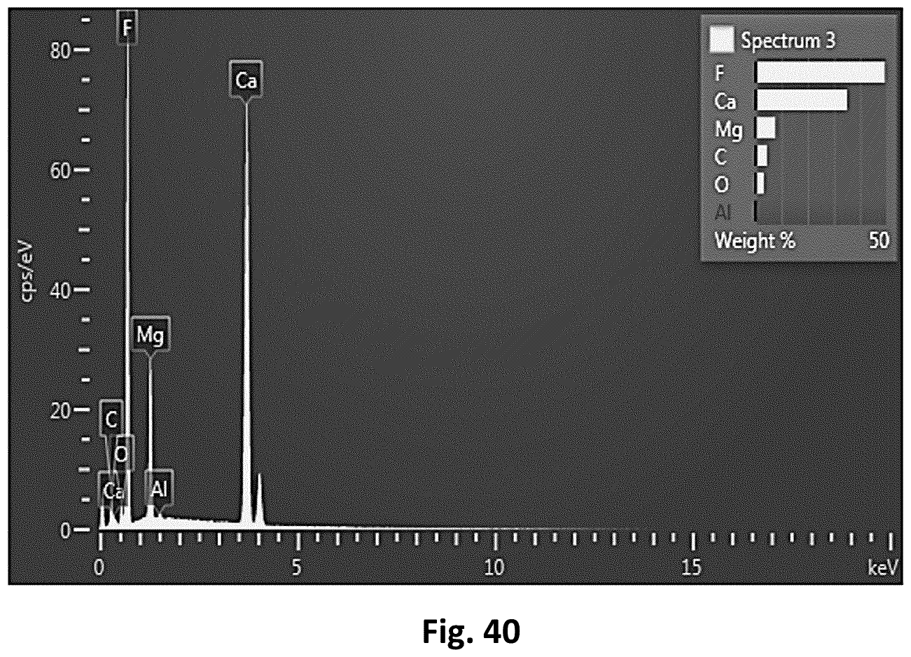

The SEM image of the CaF₂-MgF₂ nanocomposite prepared by the solid-state method is Shown in FIG. 36. The CaF₂-MgF₂ nanocomposite morphology results show that cloud of a tiny sphere shape of each particle. FIG. 37 shows EDS patterns of CaF₂-MgF₂ nanocomposite. EDS results show the existence of Calcium, magnesium, and Fluoride elements. Carbon comes from the substrate, and oxygen might be from the SEM chamber.

FIG. 35 shows XRD patterns of CaF₂-MgF₂ nanocomposite prepared by solid state method. The diffraction peaks of calcium fluoride and magnesium fluoride are clearly displayed in the XRD patterns. XRD patterns of CaF₂ were indexed by using the JCPDS database (card no. 35-0816). The annealed at 700 °C nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature. The location and intensity of reflections originating from MgF₂ sample corresponds to the data contained in the PDF database for magnesium fluoride (sellaite, JCPDS #41-1443). The annealed at 700 °C nanopowder was of Tetragonal MgF₂ with the P42/mnm(136) space group. No characteristic peaks of impurities were detected, showing that MgF₂ was a pure phase.

The SEM image of the CaF₂-MgF₂ nanocomposite prepared by the solid-state method is shown in FIG. 36. The CaF₂-MgF₂ nanocomposite morphology results show that cloud of a tiny sphere shape of each particle. FIG. 37 shows EDS patterns of CaF₂-MgF₂ nanocomposite. EDS results show the existence of Calcium, magnesium, and Fluoride elements. Carbon comes from the substrate, and oxygen might be from the SEM chamber.

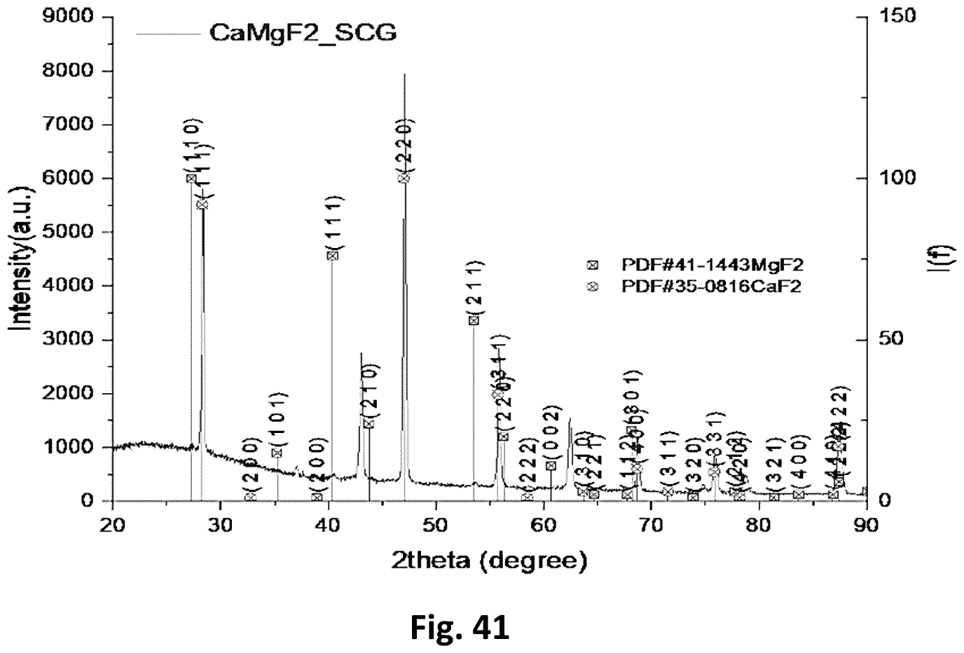

FIG. 41 shows XRD patterns of CaF₂-MgF₂ nanocomposite prepared by combustion method (Glycine as a Fuel). XRD patterns of CaF₂ were indexed by using the JCPDS database (card no. 35-0816). The annealed at 700 °C nanopowder was of cubic CaF₂ with the Fm-3m space group. No characteristic peaks of impurities were detected, showing that CaF₂ was a pure phase. The lattice parameters were calculated from the equation of plane spacing for the cubic crystal system and Bragg's law for diffraction. The lattice parameter was 5.463±0.011 Å, calculated from the obtained XRD diagram, which was in good agreement with the literature, whereas very few diffraction peaks coincide with the MgF₂ database 41-1443, so going to repeat combustion method in a different way to produce pure phase MgF₂ along with CaF₂ in MgF₂-CaF₂ nanocomposite.

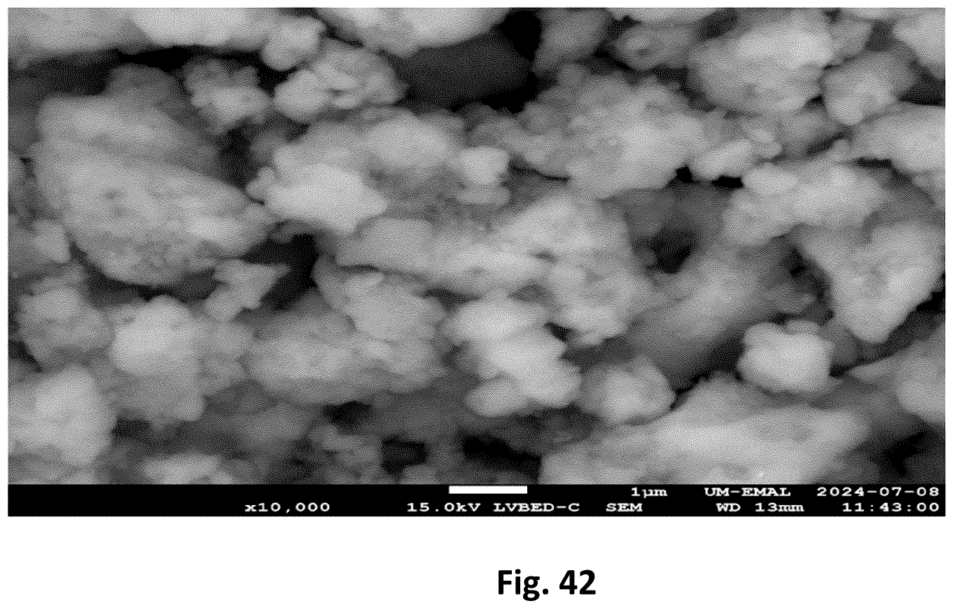

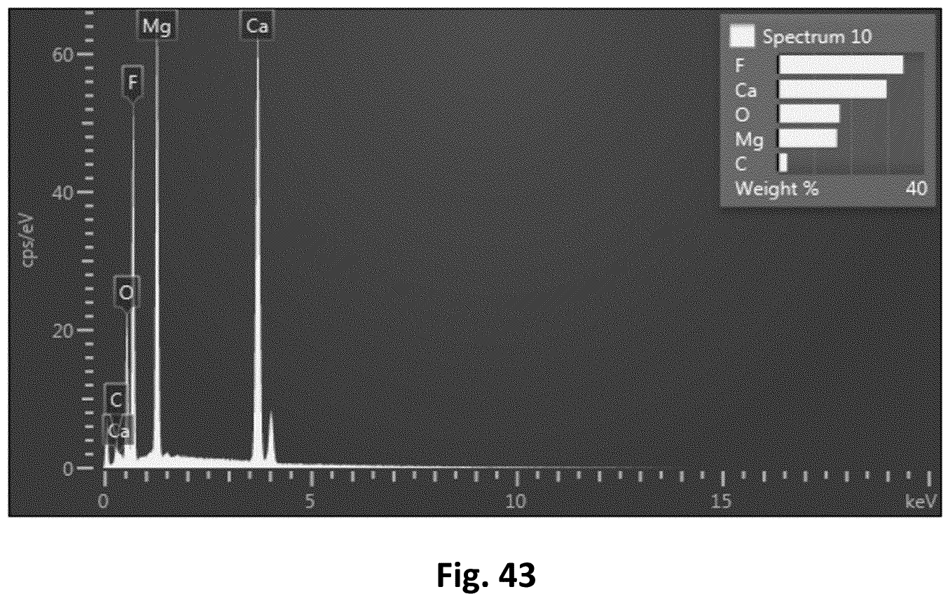

The SEM image of the CaF₂-MgF₂ nanocomposite prepared by the combustion method (Glycine as a Fuel) is Shown in FIG. 42. The CaF₂-MgF₂ nanocomposite morphology results show that cloud of a tiny sphere shape of each particle. FIG. 43 shows EDS patterns of CaF₂-MgF₂ nanocomposite. EDS results show the existence of Calcium, magnesium, and Fluoride elements. Carbon comes from the substrate, and oxygen comes from the SEM chamber.

### Spark Plasma Sintering (SPS)/Field Assisted Sintering Technique (FAST)

As a pressure-assisted and current-activated rapid sintering technique, SPS/FAST has been extensively researched in recent years as a method to process various materials, including metals, intermetallic compounds, and ceramics. It has been shown that SPS/FAST can reduce sintering time, lower sintering temperature, accelerate the rate of superplastic deformation, and retard grain growth rates, all of which make it an effective and innovative route for materials synthesis and consolidation. SPS/FAST sintering was performed under dynamic vacuum (about 0.01 mbar) using a HP-D-10 FCT System GmbH (Germany) equipment. A typical quantity of ~6 g of powder was introduced in a 20 mm diameter graphite die lined with a 0.2 mm thick Papyex® graphite foil and mounted into the SPS equipment. A standard procedure of 3 ms pulse sequence for the DC current was chosen for the sintering process. The temperature of the SPS furnace was measured using a thermocouple placed inside the graphite die, close to the sample. Powders were sintered at 600 °C, 8000 °C, 900 °C and 1100 °C under uniaxial pressures of 50 MPa (maximum recommended pressure on SPS quality graphite) applied from the beginning of the sintering cycle to the end of the dwell time with a heating rate of 100 °C/min. Dwell time at 600 °C was determined by the end of the displacement of punches was 5 minutes. At the end of the sintering process, the pressure was released before cooling started, then the DC pulses were shut down. Table 1 shows the SPS sintering parameters and results.

CaF₂ ceramic disks sintered using Spark Plasma Sintering using CaF₂ powder prepared by wet-chemical method at 600 °C, 800 °C, 900 °C, 1000 °C and 1100 °C. The disk sintered at 600 °C is not broken but the density is 82% whereas disks are sintered at 800 °C, 900 °C, 1000 °C, and 1100 °C are broken but densities are greater than 99.2%. Presently, SPS sintering parameters are optimizing to obtain fully densified and unbroken disks. The MgF₂ disk was sintered by SPS at 780 °C for 4 min with 50 MPa pressure, the disk was broken, we will HIP this broken disk to enhance density.

### CIP (Cold Isostatic Press) and HIP (Hot Isostatic Press) Sintering of the Disks

CaF₂ and MgF₂ powders (Wet-chemical synthesis and dried in Vacuum for 4 h at 700 °C) were pressed in a 1-inch diameter die to 300 MPa pressure. The green compacts of CaF₂ were then sintered at 800 °C for 2 hours in a vacuum furnace (10\hat{ }-5 torr range). The MgF₂ green compacts were sintered at 700 °C for 2 hours in the same vacuum furnace and same vacuum conditions.

CaMgF₂ powders (solid state synthesis and dried in Vacuum for 4 h at 700 °C) were pressed in a 1-inch diameter die to 300 MPa pressure. The green compacts of CaMgF₂ were sintered at 700 °C for 2 hours in a vacuum furnace (10\hat{ }-5 torr range). The CaMgF₂ compacts were HIP at 35 MPa pressure and 700 °C for 2 h. Both disks were cracked after HIP, this may be due to different thermal expansion coefficients between Mg and Ca, further HIP parameters optimization needed to obtain unbroken disk.

The CaF₂ disks appeared to have higher green compact strength compared to the MgF₂ disks. This was apparent by seeing evidence of cracking and crumbling of the MgF₂ compacts whereas the CaF₂ compacts appeared to hold together better. The MgF₂ powder would likely be a good candidate for vacuum hot pressing, which consolidates and sinters the powder in one step, thus bypassing the requirement for green strength.

The green compacts of CaF₂ were HIP at 800 °C for 2 h, 45 MPa pressure. One disk split in two during HIP, but the second disk appears to be intact. If this disk is polished down to 1 mm then it will be transparent.

The green compacts of MgF₂ were HIP at 700 °C for 2 h, 35 MPa pressure. One disk split during sintering, the second disk has some chips on the edge but mostly intact. If this disk is polished down to 1 mm then it will be transparent.

### Hot Press Sintering

Hot pressing was carried out under dynamic vacuum (about 0.2 mbar) using VAS equipment. A typical quantity of 8 g of wet chemical synthesized CaF₂ or MgF₂ powder was introduced in a 25 mm diameter graphite die coated beforehand with boron nitride (BN) to facilitate demolding. CaF₂ powder was sintered at 800 °C with a heating rate of 10 °C/min. A load of 31 MPa was applied at the selected sintering temperature (800 °C) for 1 hour. At the end of the dwell time, the pressure was released, and the sample was cooled naturally. MgF₂ powder was sintered at 675 °C with a heating rate of 10 °C/min. A load of 30 MPa was applied at the selected sintering temperature (675 °C) for 2 hours. At the end of the dwell time, the pressure was released, and the sample was cooled naturally. Graphite grades used in Hot press (HP) experiments were selected to optimize compressive strength. Also, HP dies were designed for the use of BN coating while SPS dies were designed for the use of graphite foil.

CaF₂ disk sintered by Hot Press at 800 °C, 1 h with 31 MPa, the sample came out intact and robust in appearance. Some light will transmit through the disk when holding a flashlight on the backside (not polished). After polishing this disk, it will transmit light, and it can be a readable (see-through) disk.

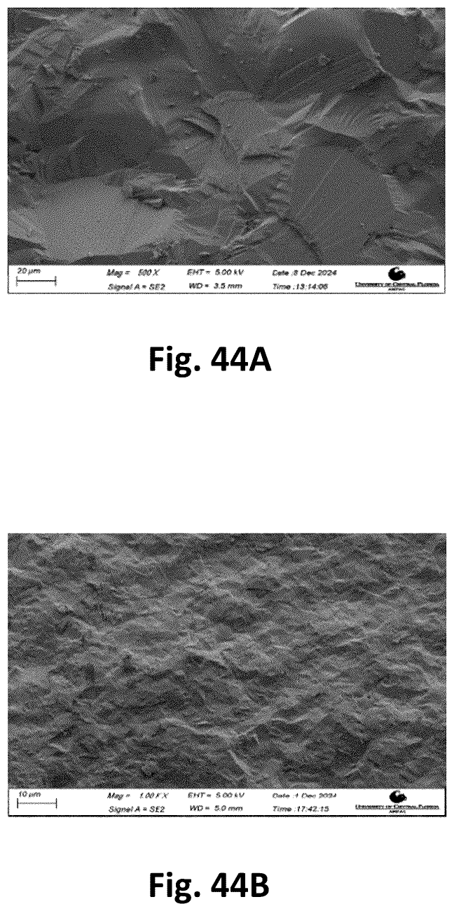

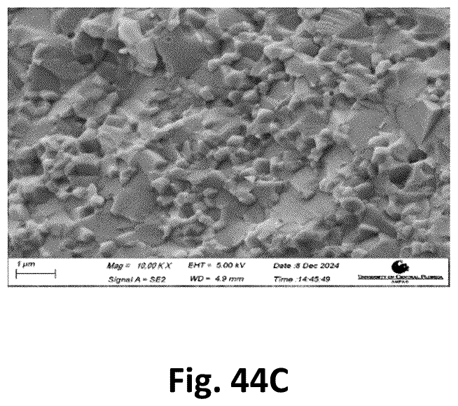

MgF2 disk sintered by Hot Press at 700 °C, 2 h with 30 MPa, the disk is discolored (likely carbon contamination) but appears to be very robust. After polishing this disk, it will transmit light, and it can be a readable (see-through) disk. CaF₂, MgF₂, and CaMgF₂ Consolidation/Sintering: CaF₂, MgF₂, and CaMgF₂ nanomaterials produced at Bhawin LLC were consolidated into disks of 20 mm diameter×4 mm thick samples (before and after exposed to flashlight. The light is passing through all sintered disks. The consolidated product shows ultrahigh density (>99%). SEM image shows nano-grained structures (FIGS. 44A-C) with no voids or porosity in the bulk optical ceramics. The polished disk samples were analyzed by FTIR and SEM.

The microstructure of ceramics was investigated to help understand its evolution during sintering and adapt the process to the powder characteristics. CaF₂ ceramics typically show well-developed dense and coarse microstructures (~50 μm average grain size) with intragranular fracture (FIG. 44A). Further effort would be necessary to limit grain growth to a few or sub-micron sizes. MgF₂ ceramics are fully dense, with an average grain size of 2 μm (FIG. 44B). Conversely, CaF₂/MgF₂ composites show well-intermixed CaF₂ grains of about 2 microns in size (smaller than in pure CaF₂ ceramics, due to grain-boundary pinning from the second phase) and MgF₂ grains of 200 to 300 nm in size. The ceramic composite is dense with little or no porosity (FIG. 44C).

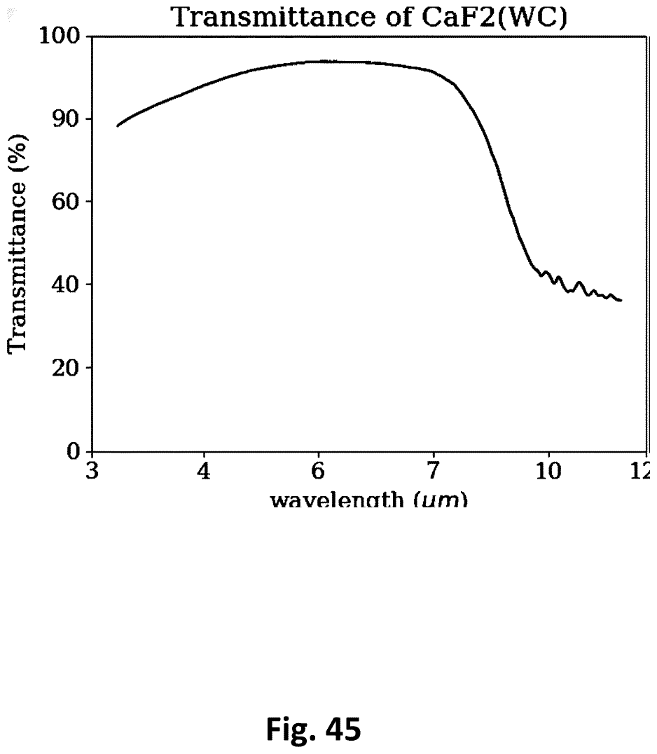

The optical transmittance spectra of the polished CaF₂(WC) #Disk (sintered using CaF₂ (WC) nanopowder by Hot Press), and polished MgF₂(WC) #Disk(sintered using MgF₂(WC) nanopowder by Hot Press), polished CaMgF₂(SS) #Disk(sintered using CaMgF₂ (SS) nanopowder by Hot Press), polished CaMgF₂(PPT) #Disk(sintered using CaMgF₂ (ppt) nanopowder by Hot Press), and polished CaMgF₂(SCG) #Disk(sintered using CaMgF₂ (SCG) nanopowder by Hot Press) are shown in FIGS. 45-49.

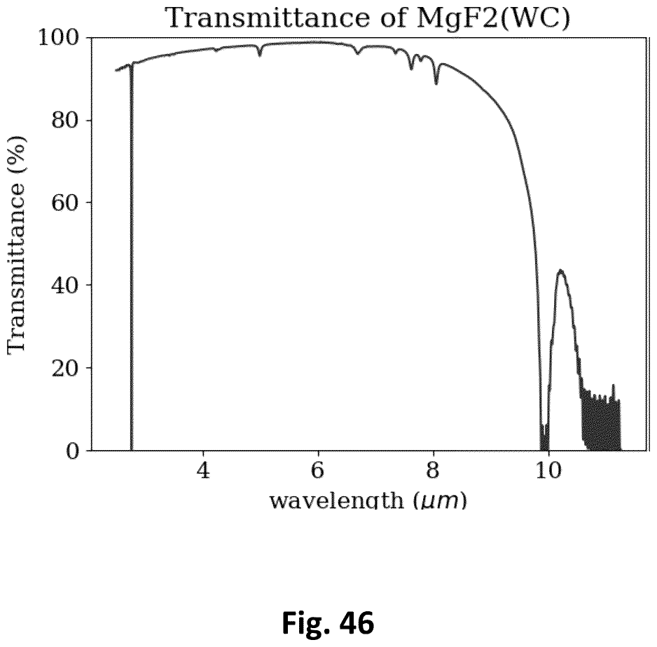

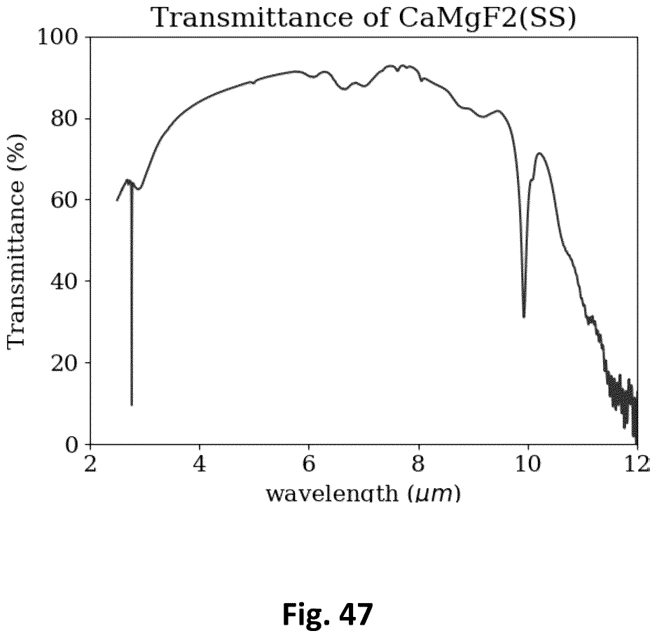

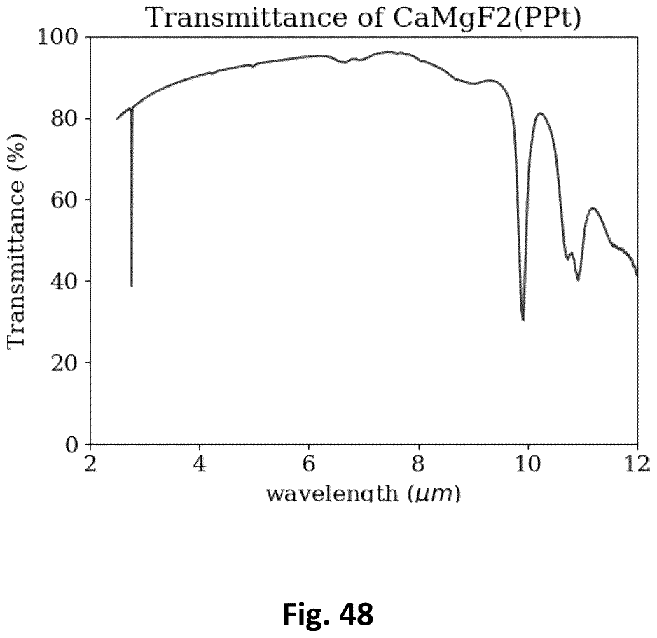

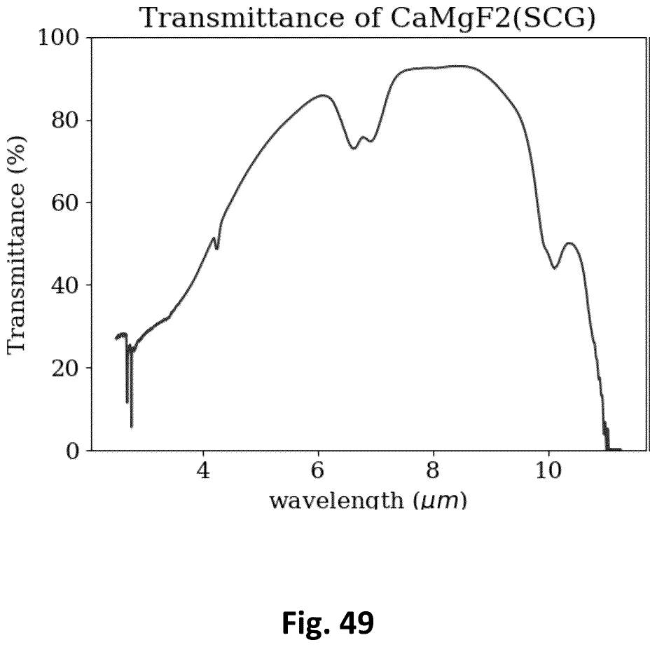

The optical transmittance of disk #a is above 80% from 2.5 μm-12 μm (FIG. 45), and no absorption peaks were observed, this represents the purity of the powder. The optical, transmittance of disk #b is above 95% from 2.5μm-8 μm (FIG. 46), which was a very desirable rate for a transparent infrared window. The peaks of 2.7, 5, and 6.6μm were related to OH-, HF₂ and OH, respectively, and peaks from 7-8 μm were related to NH4⁺. The intensity decrement of the adsorption peak at 5 μm, 6.6 μm, and 7-8 μm had a direct effect on the formation of hydroxylfluoride complexes. The calcination process might be useful to reduce the amount of adsorption in the infrared region. The optical transmittance of disk #c is 80% from 4 μm-9 μm (FIG. 47). The absorption peak at 2.7 μm comes from MgF₂ (related to OH⁻). The optical transmittance of disk #d is above 90% from 3 μm-9 μm (FIG. 48). The absorption peak at 2.7 μm comes from MgF₂ (related to OH⁻). The absorption peak at 2.7 μm comes from MgF₂ (related to OH⁻). The optical transmittance of disk #d is above 60% from 5 μm-9 μm (FIG. 49). The absorption peak at 2.7 μm comes from MgF₂ (related to OH⁻), and the broad peak at 7 μm related to OH. Based on FTIR results, precipitation method powder shows higher transmittance in producing CaF₂-MgF₂ blend disks.

What is claimed is:

1. A fluoride-based nanocomposite, comprising:
a first phase of calcium fluoride (CaF₂); and
a second phase of magnesium fluoride (MgF₂) uniformly dispersed within the calcium fluoride matrix,
wherein the nanocomposite is stable at temperatures below approximately 984 °C, has a relative density of at least 99%, and exhibits optical transmittance greater than 90% in the 3-9 μm infrared wavelength range.

2. The nanocomposite of claim 1, wherein an average grain size of the CaF₂ first phase is between 2 μm and 50 μm, and an average grain size of the MgF₂ second phase is between 200 nm and 2 μm.

3. The nanocomposite of claim 1, wherein the MgF₂ second phase acts as a grain boundary pinning agent that suppresses grain growth of CaF₂ and enhances mechanical strength.

4. The nanocomposite of claim 1, wherein a refractive index difference between the CaF₂ first phase and the MgF₂ second phase is less than 0.05, thereby reducing scattering losses.

5. The nanocomposite of claim 1, exhibiting a long-wavelength cutoff beyond 8 μm and an emissivity less than 0.3.

6. A method of producing a fluoride-based nanocomposite, comprising:
synthesizing calcium fluoride (CaF₂) and magnesium fluoride (MgF₂) nanopowders via one or more methods selected from the group consisting of precipitation, hydrothermal synthesis, wet-chemical synthesis, combustion synthesis, and solid-state reaction;
mixing the nanopowders to form a precursor having a predetermined CaF₂-to-MgF₂ ratio;
drying and milling the precursor to achieve a particle size between 50 nm and 1000 nm; and
densifying the precursor using one or more techniques selected from the group consisting of spark plasma sintering (SPS), hot pressing (HP), cold isostatic pressing (CIP), and hot isostatic pressing (HIP),
wherein the densification is conducted under controlled atmosphere conditions to achieve a relative density greater than 99% and an infrared transmittance exceeding 90% in the 3-9 μm range.

7. The method of claim 6, wherein MgF₂ is incorporated as a second-phase particle to inhibit grain growth in CaF₂ through grain boundary pinning or Zener drag mechanisms.

8. The method of claim 6, further comprising applying boron nitride (BN) coatings to sintering dies and graphite tooling to improve surface finish and facilitate demolding.

9. The method of claim 6, wherein densification is performed at a temperature between 600 °C and 1100 °C for 0.5-4 hours under a vacuum or inert gas atmosphere.

10. The method of claim 6, further comprising polishing the sintered ceramic to optical quality to produce disks exhibiting optical transmittance greater than 90% in the 3-9 μm wavelength range.

11. An infrared-transparent component comprising a fluoride-based nanocomposite, the fluoride-based nanocomposite comprising:
a first phase of calcium fluoride (CaF₂); and
a second phase of magnesium fluoride (MgF₂) uniformly dispersed within the calcium fluoride matrix,
wherein the nanocomposite is stable at temperatures below approximately 984 °C, has a relative density of at least 99%, and exhibits optical transmittance greater than 90% in the 3-9 μm infrared wavelength range.

12. The infrared-transparent component of claim 11, wherein the component is operable in thermal or mechanical environments exceeding 600 °C while maintaining structural integrity and optical performance.

13. The infrared-transparent component of claim 11, wherein the component is an infrared window exhibiting emissivity less than 0.3 and high resistance to thermal shock.

14. The infrared-transparent component of claim 11, wherein the component exhibits broadband transmittance of at least 85% across the 3-12 μm range and a fracture strength greater than 150 MPa.

15. The infrared-transparent component of claim 11, wherein the component is a ceramic disk having a thickness between 0.5 mm and 5 mm and maintains greater than 90% optical transmittance after polishing.
